(19) United States
(12) Patent Application Publication
(10) Pub. No.: US 2025/0295282 A1
(43) Pub. Date: Sep. 25, 2025

(54) STATION AND CLEANING DEVICE HAVING THE SAME

(71) Applicant: SAMSUNG ELECTRONICS CO., LTD., Suwon-si (KR)

(72) Inventors: Sinae KIM, Suwon-si (KR); Byeongwoo AHN, Suwon-si (KR); Jungmin KO, Suwon-si (KR)

(73) Assignee: SAMSUNG ELECTRONICS CO., LTD., Suwon-si (KR)

(21) Appl. No.: 19/084,157

(22) Filed: Mar. 19, 2025

Related U.S. Application Data
(63) Continuation of application No. PCT/KR2025/001986, filed on Feb. 11, 2025.

(30) Foreign Application Priority Data
Mar. 20, 2024 (KR) 10-2024-0038763
Jun. 20, 2024 (KR) 10-2024-0080652

(51) Int. Cl. A47L 9/28; A47L 11/40

(52) U.S. Cl. CPC A47L 9/2873; A47L 11/4086; A47L 2201/022; A47L 2201/028

(57) ABSTRACT

A station, to which a robot cleaner (RC) including a wettable mop (WM) that is rotatable by the RC, is dockable, may include: a tank to store water; a washing chamber; and a wash frame in the washing chamber and including: a body dividing the washing chamber into a first region (FR) and a second region (SR), an opening penetrating the body and connecting the FR to the SR, and a scraper crossing the opening and including: a first scraper having a through-hole, and a second scraper to receive water from the tank, wherein the station is configured so that, with the RC docked, the WM accommodated in the FR and rotated by the RC, the received water is supplied to the WM and the first and second scraper apply frictional forces to the WM to remove dirt from the WM through the opening and through-hole to the SR.

### CROSS-REFERENCE TO RELATED APPLICATIONS

This is a continuation application, under 35 U.S.C. § 111 (a), of International Application PCT/KR2025/001986, filed Feb. 11, 2025, which claims priority under 35 U.S.C. § 119 to Korean Patent Application No. 10-2024-0038763, filed Mar. 20, 2024 and Korean Patent Application No. 10-2024-0080652, filed Jun. 20, 2024, in the Korean Intellectual Property Office, the disclosures of which are incorporated herein in their entireties by reference.

### TECHNICAL FIELD

The present disclosure relates to a station for a robot cleaner including a wet mop and a cleaning device including the same.

### BACKGROUND ART

In general, a robot cleaner refers to a device that automatically cleans a space to be cleaned by sucking up dirt such as dusts accumulated on the floor while traveling the space to be cleaned without user's manipulation. The robot cleaner cleans the space to be cleaned while traveling the space to be cleaned.

The robot cleaner cleans a cleaning zone by detecting a distance to an obstacle such as furniture, office suppliers, and walls installed in a cleaning zone by using a distance sensor and shifting a direction by itself by selectively driving left wheel and right wheel motors of the robot cleaner.

In recent years, as well as robot cleaners sucking up foreign substances such as dusts on the floor, robot cleaners that wipe away foreign substances such as dusts on the floor are emerging. Robot cleaners may perform wet cleaning by using a wet mop.

A robot cleaner may be mounted on a station. The station may be configured to charge the robot cleaner and remove dusts and the like collected in the robot cleaner while the robot cleaner is mounted thereon.

### DISCLOSURE

### Technical Problem

Provided are a station having enhanced user convenience and a cleaning device including the same.

Provided are a station capable of maintaining and managing a wet mop clean and a cleaning device including the same.

Provided are a station having a structure for effectively washing a wet mop and a cleaning device including the same.

Provided are a station capable of managing a wash frame for washing a wet mop clean and a cleaning device including the same.

However, the technical problems to be solved by the present disclosure are not limited to the aforementioned problems, and any other technical problems not mentioned herein will be clearly understood from the following description by those skilled in the art to which the present disclosure pertains.

### Technical Solution

In accordance with the present disclosure, a station to which a robot cleaner is dockable, the robot cleaner including a wettable mop that is rotatable by the robot cleaner to wipe dirt from a surface to be cleaned, the station may include: a washing chamber; and a wash frame in the washing chamber and including: a frame body dividing the washing chamber into a first region and a second region, an opening penetrating the frame body and connecting the first region to the second region, and a scraper crossing the opening and including: a first scraper having a through-hole connecting the first region to the second region, and a second scraper spaced apart from the first scraper and configured to receive water stored in a tank, wherein the station may be configured so that, with the robot cleaner docked to the station, the wettable mop is accommodable in the first region of the washing chamber, and with the wettable mop accommodated in the first region and rotated by the robot cleaner, water received by the second scraper is supplied to the wettable mop to wet the wettable mop and frictional forces are applied to the wettable mop by the first scraper and the second scraper so as to remove dirt from the wettable mop through the opening and the through-hole to the second region.

The frame body may form a rim of the opening, the first scraper may include a friction body protruding from a surface of the frame body and may have a friction surface facing the first region, the through-hole may penetrate the friction body, and the first scraper may be configured so that, with the robot cleaner docked to the station and with the wettable mop accommodated in the first region, the friction surface contacts the wettable mop.

The friction body may extend toward a center of the opening and may divide the opening into a first opening region and a second opening region spaced apart from the first opening region, and the first opening region, the friction body, and the second opening region may be configured so that, with the robot cleaner docked to the station, the wettable mop accommodated in the first region, and the wettable mop rotated by the robot cleaner, the wettable mop rotates sequentially in a first direction from the first opening region, to the friction body, and then to the second opening region.

The first scraper may further include a guide rib that is inclined upwards with respect to the first direction from the first opening region toward the friction surface, and the first scraper may be configured so that, with the robot cleaner docked to the station, the wettable mop accommodated in the first region, and the wettable mop rotated by the robot cleaner, the guide rib guides a lower surface of the wettable mop from the first opening region to the friction surface.

The guide rib may be connected to a surface of the friction surface facing the first opening region.

The frame body may form a rim of the opening, the second scraper may include a friction body protruding from a surface of the frame body and may have a friction surface facing the first region, and the second scraper may be configured to allow the received water to flow along the second scraper.

The washing chamber may include a water supply nozzle on a first side wall of the washing chamber facing the first region, and the wash frame may further include a water spray hole formed at the frame body and configured so that water stored in the tank passes through the water supply nozzle and the water spray hole to be received by the second scraper.

The friction body may include a pair of water guide walls protruding from the friction surface along a lengthwise direction of the friction body and configured to guide the received water along the second scraper.

The water supply nozzle may be inclined in a direction in which the friction surface extends.

The station may further include: a steam generating device including: a steam chamber configured to hold water, and a heater configured to heat the water held in the steam chamber to generate steam, and the washing chamber may further include a steam supply opening on a second side wall of the washing chamber facing the second region, the wash frame may include: a steam inlet opening communicating with the steam supply opening, and a steam spray hole communicating with the steam inlet opening and extending from the rim of the opening into the second region, and the steam generating device, the washing chamber and the wash frame may be configured so that steam generated by the heater flows through the steam supply opening, then through the steam inlet opening, and then through the steam spray hole to be discharged to the second region.

The station may further includes: a drying device including a fan configured to generate a flow of air, and the washing chamber may further include an air supply opening, the wash frame may further include an air spray hole formed through the frame body, and the drying device, the washing chamber and the wash frame may be configured so that the flow of the air generated by the fan flows through the air supply opening, and then through the air spray hole to be sprayed toward the first region and the second region.

A diameter of the opening may be less than a diameter of the wettable mop.

The frame body may further include a mop support along the rim of the opening and along a radial direction of the opening, and configured so that, with the robot cleaner docked to the station and the wettable mop accommodated in the first region, the mop support supports the wettable mop.

The station may further include: a drainage frame in the washing chamber and detachably coupled to the wash frame, wherein the drainage frame is in the second region and is configured to accommodate the dirt removed from the wettable mop through the opening and the through-hole.

The washing chamber may include a dirt drain hole having a first diameter at a bottom of the washing chamber, the drainage frame may further include a filtering hole having a second diameter that is smaller than the first diameter, and the washing chamber and the drainage frame may be configured so that the dirt removed from the wettable mop through the opening and the through-hole is transferred through the filtering hole to the dirt drain hole.

The cleaning device according to the present disclosure includes a robot cleaner including a cleaner main body and a wet mop detachably coupled to the cleaner main body and rotatable and a station configured to be mounted with the robot cleaner. The station may include a base including a washing chamber corresponding to the wet mop in the case where the robot cleaner is mounted thereon and configured to supply wash water to the washing chamber and a wash frame disposed in the washing chamber to allow the wet mop to be seated thereon. The wash frame includes a frame body dividing the washing chamber into a first region and a second region other than the first region, an opening formed to penetrate the frame body to allow the first region to communicate with the second region and covered with the wet mop, a first scraper disposed in the opening and including a first friction body having a first friction surface configured to rub the wet mop and a through-hole formed to penetrate the first friction body, and a second scraper disposed in the opening to be spaced apart from the first scraper and including a second friction body to receive the wash water.

The cleaning device according to the present disclosure includes a robot cleaner including a cleaner main body and a wet mop detachably coupled to the cleaner main body and a station mounted with the robot cleaner and configured to wash the wet mop. The station includes a washing chamber corresponding to the wet mop in the case where the robot cleaner is mounted, and a wash frame disposed in the washing chamber and allowing the wet mop to be seated thereon. The wash frame may include a frame body allowing the wet mop to be seated thereon, an opening penetrating the frame body in the vertical direction, a first scraper disposed in the opening and including a first friction body rubbing the wet mop and a through-hole penetrating the first friction body in the vertical direction, and a second scraper disposed in the opening and provided to receive wash water and supply wash water to the wet mop.

### DESCRIPTION OF DRAWINGS

FIG. 1 is a view illustrating a state where a robot cleaner is out of a station in a cleaning device according to an embodiment.

FIG. 2 is a view illustrating a state where a robot cleaner is seated on a station in a cleaning device according to an embodiment.

FIG. 3 is a view illustrating the rear of the cleaning device illustrated in FIG. 2.

FIG. 4 is a view illustrating a robot cleaner according to an embodiment.

FIG. 5 is a view illustrating the rear of the robot cleaner shown in FIG. 4.

FIG. 6 is a view illustrating the bottom of the robot cleaner shown in FIG. 4.

FIG. 7 is a view illustrating a station according to an embodiment.

FIG. 8 is a view illustrating the rear of the station shown in FIG. 7.

FIG. 9 is a rear view of the station shown in FIG. 7.

FIG. 10 is a partial view of a station according to an embodiment.

FIG. 11 is a view illustrating a state where a wash frame is separated from a washing chamber in a station according to an embodiment.

FIG. 12 is a state where a drainage frame is separated from the washing chamber in FIG. 11.

FIG. 13 is a view illustrating that a wash frame is separated from a wet mop in a cleaning device according to an embodiment.

FIG. 14 is a view of a wash frame in a cleaning device according to an embodiment viewed from a different angle.

FIG. 15 is an enlarged view of a partial cross-section of a cleaning device according to an embodiment.

FIG. 16 is a view illustrating that a wash frame is separated from a drainage frame in a cleaning device according to an embodiment.

FIG. 17 is a view illustrating a wash frame in a cleaning device according to an embodiment.

FIG. 18 is a view illustrating a drainage frame in a cleaning device according to an embodiment.

FIG. 19 is a cross-sectional view taken along line A-A′ of FIG. 3.

FIG. 20 is a cross-sectional view taken along line B-B′ of FIG. 3.

FIG. 21 is a cross-sectional view taken along line C-C′ of FIG. 3 in which the robot cleaner is removed and the wet mop is disposed.

### MODE FOR INVENTION

The embodiments described in the specification and shown in the drawings are only illustrative and are not intended to represent all aspects of the present disclosure, such that various equivalents and modifications may be made without departing from the spirit of the present disclosure.

In addition, like reference numerals denote like elements or components having substantially same functions in the drawings.

Also, the terms used herein are merely used to describe particular embodiments, and are not intended to limit the present disclosure. An expression used in the singular encompasses the expression of the plural, unless otherwise indicated. Throughout the specification, the terms such as “including” or “having” are intended to indicate the existence of features, numbers, processes, operations, components, parts, or combinations thereof disclosed in the specification, and are not intended to preclude the possibility that one or more other features, numbers, processes, operations, components, parts, or combinations thereof may exist or may be added.

In addition, it will be understood that, although the terms “first”, “second”, etc., may be used herein to describe various elements, these elements should not be limited by these terms. The above terms are used only to distinguish one component from another. For example, a first component discussed below could be termed a second component, and similarly, the second component may be termed the first component without departing from the teachings of this disclosure. As used herein, the term “and/or” includes any combinations of one or more of the associated listed items.

Meanwhile, the shape and position of each element are not limited by the terms “front”, “rear”, “left”, “right”, “above”, “below” and the like used throughout the specification.

When an element is mentioned as being “connected to”, “coupled to”, “supported on”, or “contacting” another element, it includes not only a case that the elements are directly connected to, coupled to, supported on or contact each other but also a case that the elements are connected to, coupled to, supported on or contact each other through a third element.

When an element is mentioned as being located “on” another element, it implies not only that the element is abut on the other element but also that a third element exists between the two elements.

When referring to directions of rotation, clockwise direction may be referred to as first direction, and counterclockwise direction, opposite direction to the first direction, may be referred to as second direction. These expressions may be commonly used to provide detailed description of the present disclosure, but the rotation direction of the components of the present disclosure is not limited by these expressions.

Hereinafter, embodiments of the present disclosure will be described in detail with reference to the accompanying drawings.

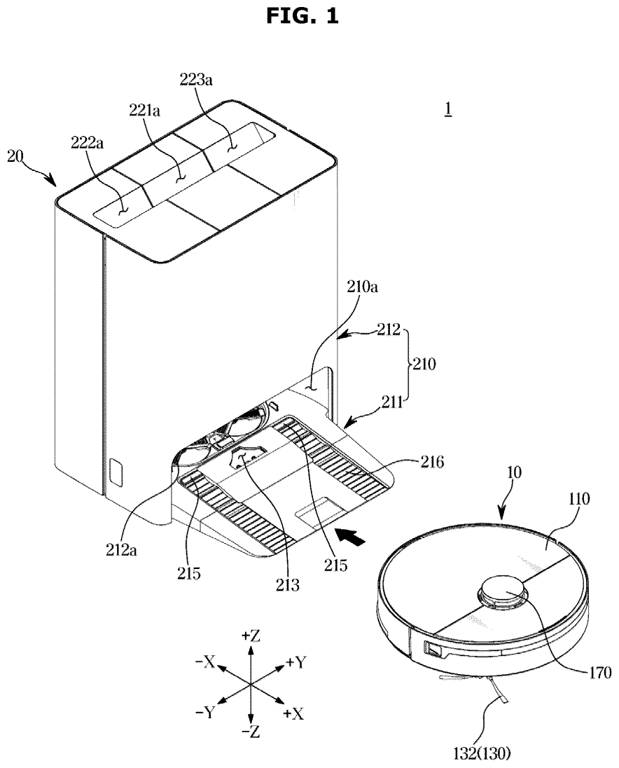

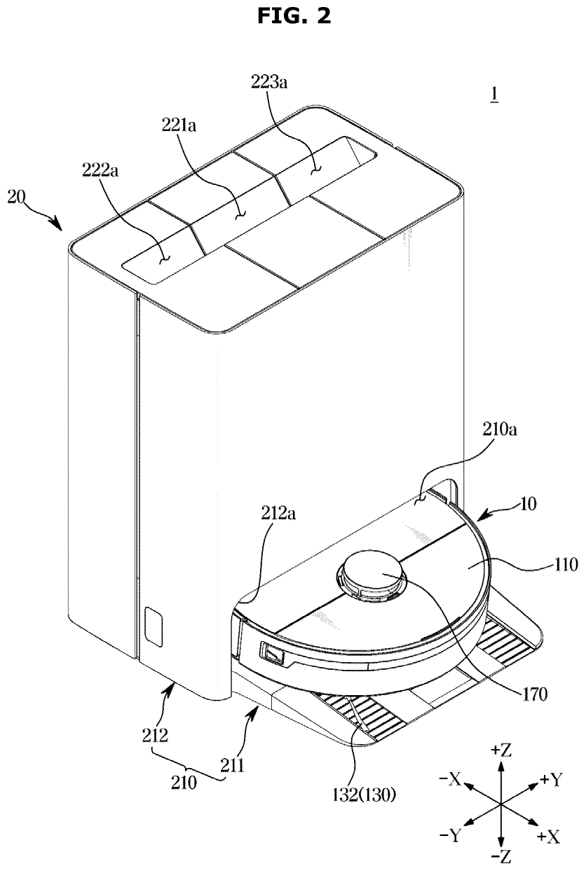

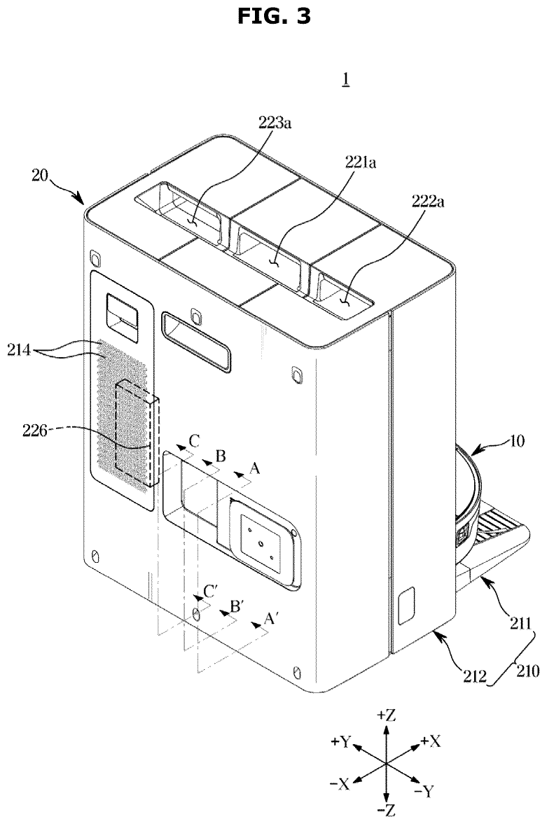

FIG. 1 is a view illustrating a state where a robot cleaner is out of a station in a cleaning device according to an embodiment. FIG. 2 is a view illustrating a state where a robot cleaner is seated on a station in a cleaning device according to an embodiment. FIG. 3 is a view illustrating the rear of the cleaning device illustrated in FIG. 2.

Referring to FIGS. 1 to 3, a cleaning device 1 may include a robot cleaner 10 and a station 20. The cleaning device 1 may be referred to as cleaning system 1.

The robot cleaner 10 may clean the surface of the floor while moving along the surface of the floor. The surface of the floor cleaned by the robot cleaner 10 may be referred to as a surface to be cleaned. The robot cleaner 10 may perform dry cleaning and/or wet cleaning. The robot cleaner 10 may suck up or wipe away dirt on the surface to be cleaned. Here, dirt may be a general term for foreign substances such as dust, hair, and food crumbs.

The robot cleaner 10 may be seated on the station 20. The robot cleaner 10 may be mounted on the station 20. The robot cleaner 10 may be docked on the station 20. At least a part of the robot cleaner 10 may be disposed in an accommodation space 210a of the station 20.

The robot cleaner 10 may move to the station 20 during cleaning and/or after completion of cleaning.

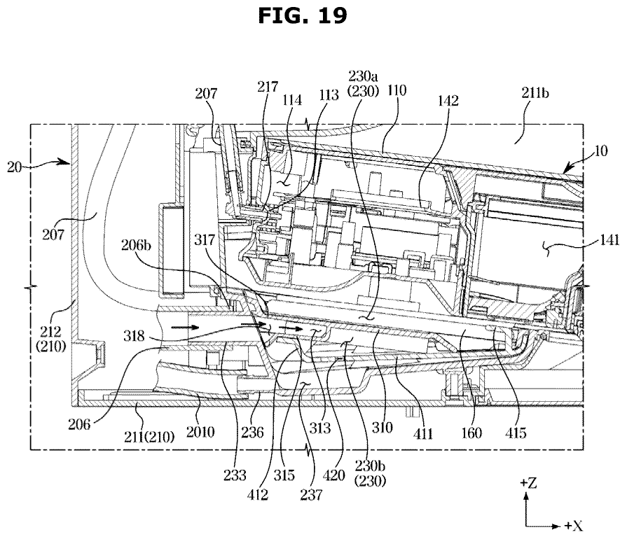

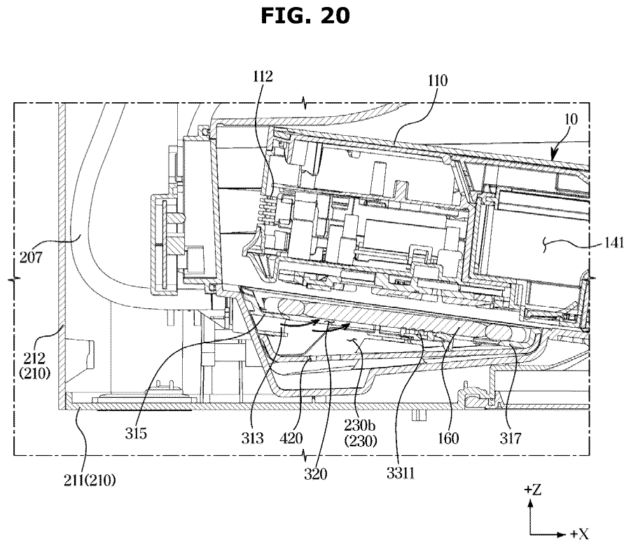

For example, the robot cleaner 10 may move to the station 20, in the case where charging is required, dirt contained in a dustbin 141 (See FIGS. 19 and 20) is required to be emptied, water in a water tank 114 (See FIG. 19) is insufficient, a moisture content of a wet mop 160 is low, the wet mop 160 is required to be washed, the wet mop 160 is required to be sterilized, and/or the wet mop 160 is required to be dried.

The station 20 may be provided to allow the robot cleaner 10 to be mounted thereon. The station 20 may be provided to allow the robot cleaner 10 to be seated thereon. The station 20 may be provided to store the robot cleaner 10.

For example, while the robot cleaner 10 is seated on the station 20, the station 20 may charge a battery (not shown) of the robot cleaner 10. For example, while the robot cleaner 10 is seated on the station 20, the station 20 may collect dirt collected in the dustbin 141 of the robot cleaner 10. For example, while the robot cleaner 10 is seated on the station 20, the station 20 may supply water to the water tank 114 of the robot cleaner 10. For example, while the robot cleaner 10 is seated on the station 20, the station 20 may wet the wet mop 160 with water and/or steam. For example, while the robot cleaner 10 is seated on the station 20, the station 20 may wash the wet mop 160. For example, while the robot cleaner 10 is seated on the station 20, the station 20 may sterilize the wet mop 160. For example, while the robot cleaner 10 is seated on the station 20, the station 20 may dry the wet mop 160.

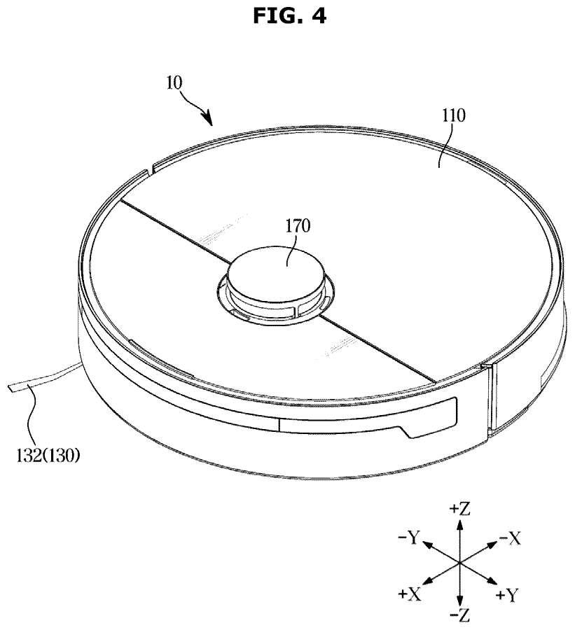

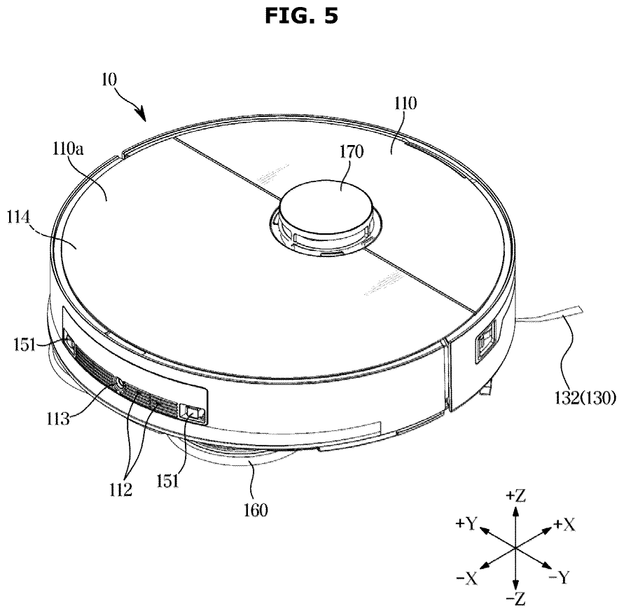

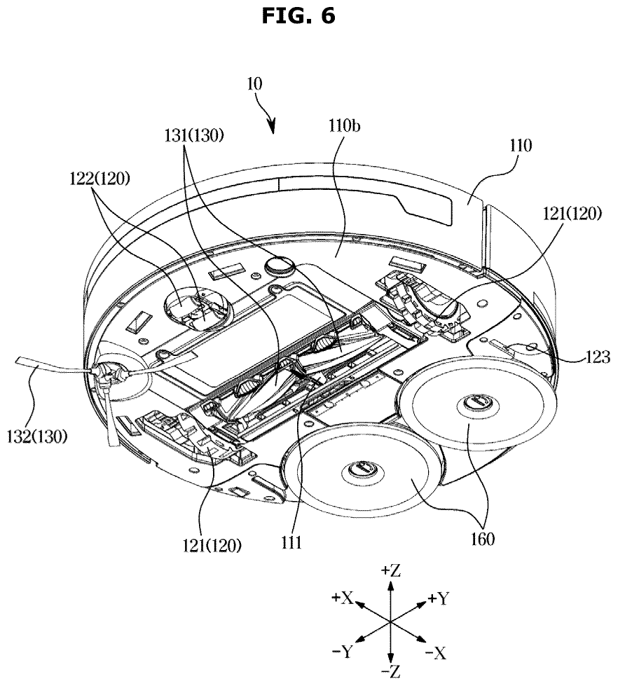

FIG. 4 is a view illustrating a robot cleaner according to an embodiment. FIG. 5 is a view illustrating the rear of the robot cleaner shown in FIG. 4. FIG. 6 is a view illustrating the bottom of the robot cleaner shown in FIG. 4.

The robot cleaner 10 may include a main body 110. The main body 110 may define the overall exterior appearance of the robot cleaner 10. Components of the robot cleaner 10 may be accommodated in the main body 110. Electric components may be disposed in the main body 110. The main body 110 may be referred to as cleaner main body 110.

The robot cleaner 10 may include an intake port 111. The intake port 111 may be formed to face the surface to be cleaned. The intake port 111 may be open to the surface to be cleaned. The intake port 111 may be formed at the main body 110. The intake port 111 may be formed at the bottom of the main body 110. The intake port 111 may be formed to penetrate a lower surface 110b of the main body 110. Dirt on the surface to be cleaned may be sucked together with air into the main body 110 through the intake port 111. The intake port 111 may be referred to as cleaner intake port 111.

The robot cleaner 10 may include a brush 130. The brush 130 may scatter dirt by striking the surface to be cleaned. The dirt scattered by the brush 130 may be introduced into the intake port 111 with air.

For example, the robot cleaner 10 may include a first brush 131 disposed at the intake port 111. The first brush 131 may be mounted to be rotatable with respect the main body 110. A rotation axis of the first brush 131 may be an axis extending in an approximately horizontal direction (Y direction). The first brush 131 may be referred to as main brush 131.

For example, the robot cleaner 10 may include a second brush 132 disposed adjacent to a lower rim of the main body 110. The second brush 132 may guide dirt around the main body 110 that cannot be swept by the first brush 131 to the intake port 111. The second brush 132 may be mounted to be rotatable with respect to the main body 110. A rotation axis of the second brush 132 may be an axis extending in an approximately vertical direction (Z direction). The second brush 132 may be referred to as side brush 132.

The robot cleaner 10 may include a dustbin 141 (See FIG. 19). The dirt and/or air sucked through the intake port 111 may move to the dustbin 141. The dirt introduced through the intake port 111 may be collected in the dustbin 141. Air introduced through the intake port 111 may be filtered while passing through the dustbin 141. The dirt and air introduced through the intake port 111 may be separated from each other in the dustbin 141.

The robot cleaner 10 may include an exhaust port 112. The exhaust port 112 may be formed at the main body 110. The exhaust port 112 may be formed at the rear of the main body 110. Air introduced through the intake port 111 may be filtered and discharged out of the robot cleaner 10 through the exhaust port 112. For example, the exhaust port 112 may be provided in plural, and the plurality of exhaust ports may be formed as a plurality of holes. The exhaust port 112 may be referred to as cleaner exhaust port 112.

The robot cleaner 10 may include an intake motor 142 (See FIG. 19). The intake motor 142 may generate suction power. The intake port 111 may suck dirt and/or air by the suction power generated by the intake motor 142. The exhaust port 112 may discharge air, which is introduced into the robot cleaner 10 and filtered, to the outside by the suction power generated by the intake motor 142. The intake motor 142 may be disposed in an air flow path formed between the intake port 111 and the exhaust port 112. The intake motor 142 may be referred to as cleaner intake motor 142.

The robot cleaner 10 may include a traveling device 120 for traveling of the robot cleaner 10. The traveling device 120 may be mounted on the main body 110 to move the main body 110. For example, the traveling device 120 may include a pair of main wheels 121. For example, the traveling device 120 may further include at least one auxiliary wheel for safe traveling of the robot cleaner 10.

The robot cleaner 10 may include a battery (not shown). The battery may be rechargeable. The battery may provide power required to drive the robot cleaner 10. For example, the battery may be detachably mounted in the robot cleaner 10.

The robot cleaner 10 may include a charging terminal 151. The charging terminal 151 may be electrically connected to the battery. While the robot cleaner 10 is seated on the station 20, the charging terminal 151 of the robot cleaner 10 may be electrically connected to a charging terminal 218 of the station 20. Because the charging terminal 151 of the robot cleaner 10 is electrically connected to the charging terminal 218 of the station 20, the battery of the robot cleaner 10 may be charged. That is, while the robot cleaner 10 is docked on the station 20, the battery may be charged. The charging terminal 151 may be referred to as cleaner charging terminal 151.

The robot cleaner 10 may include the wet mop 160. The wet mop 16 may be detachably mountable on the bottom of the main body 110. The wet mop 160 may be mounted to be rotatable with respect to the main body 110.

The wet mop 160 may be provided to clean the surface to be cleaned in contact with the surface to be cleaned. The wet mop 160 may wipe off dirt on the surface to be cleaned in a wet state. Although two wet mops 160 are shown in the drawing, the number of the wet mops 160 is not limited. The wet mop 160 may be referred to as clean pad 160. The wet mop 160 may be referred to as wet pad 160.

The wet mop 160 may receive moisture from the water tank 114 of the robot cleaner 10. The wet mop 160 may receive moisture from the station 20. For example, in the case where the moisture content of the wet mop 160 decreases while the robot cleaner 10 performs cleaning, water stored in the water tank 114 may be supplied to the wet mop 160. For example, in the case where the moisture content of the wet mop 160 decreases while the robot cleaner 10 performs cleaning, the robot cleaner 10 may return to the station 20 to be seated on the station 20. In this case, the station 20 may supply water to the water tank 114 or spray water and/or steam toward the wet mop 160. The state where the robot cleaner 10 is seated on the station 20 may include a state where the robot cleaner 10 is docked on the station 20.

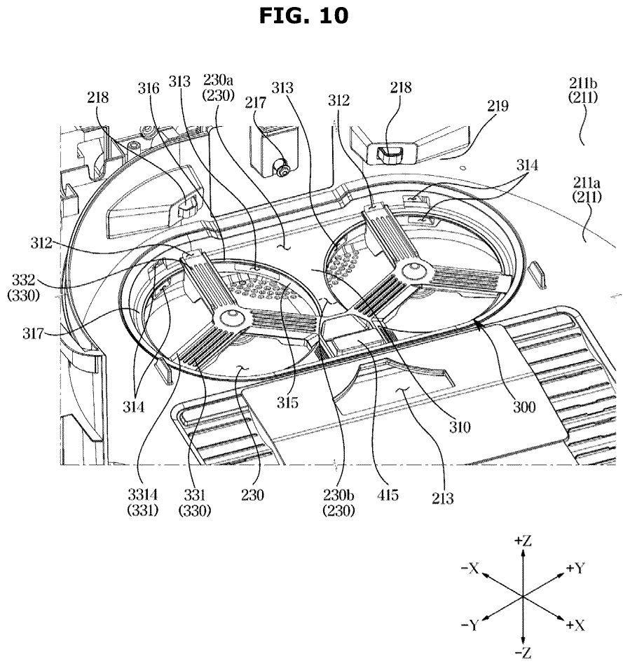

The robot cleaner 10 may include a water filling port 113. The water filling port 113 may be formed at the main body 110. The water filling port 113 may be formed at the rear of the main body 110. While the robot cleaner 10 is seated on the station 20, the water filling port 113 may receive water supplied from the station 20. Water supplied to the robot cleaner 10 through the water filling port 113 may be stored in the water tank 114. While the robot cleaner 10 is seated on the station 20, the water filling port 113 of the robot cleaner 10 may be docked with the water suppling port 217 (See FIG. 10 of the station 20.

The robot cleaner 10 may include a rotation drive unit (not shown) configured to rotate the wet mop 160. The rotation drive unit may include a motor. For example, while the wet mop 160 is washed and/or sterilized after the robot cleaner 10 is mounted on the station 20, the motor may rotate the wet mop 160.

The robot cleaner 10 may include a lifting drive unit (not shown) configured to move the wet mop 160 up and down. While the robot cleaner 10 performs cleaning, the lifting drive unit may move the wet mop 160 downwards. Therefore, the wet mop 160 may be in contact with the surface to be cleaned. While the robot cleaner 10 returns to the station 20 after completion of cleaning, the lifting drive unit may move the wet mop 160 upwards. Therefore, the wet mop 160 may be spaced apart from the surface to be cleaned. Therefore, collision between the wet mop 160 and an obstacle on the surface to be cleaned and unnecessary residue of moisture on the surface to be cleaned may be prevented.

The robot cleaner 10 may include an obstacle detection sensor 170. The obstacle detection sensor 170 may be configured to detect a position of an obstacle or a distance to the obstacle. The obstacle detection sensor 170 may be mounted on the main body 110. For example, the obstacle detection sensor 170 may protrude from an upper surface 110a of the main body 110.

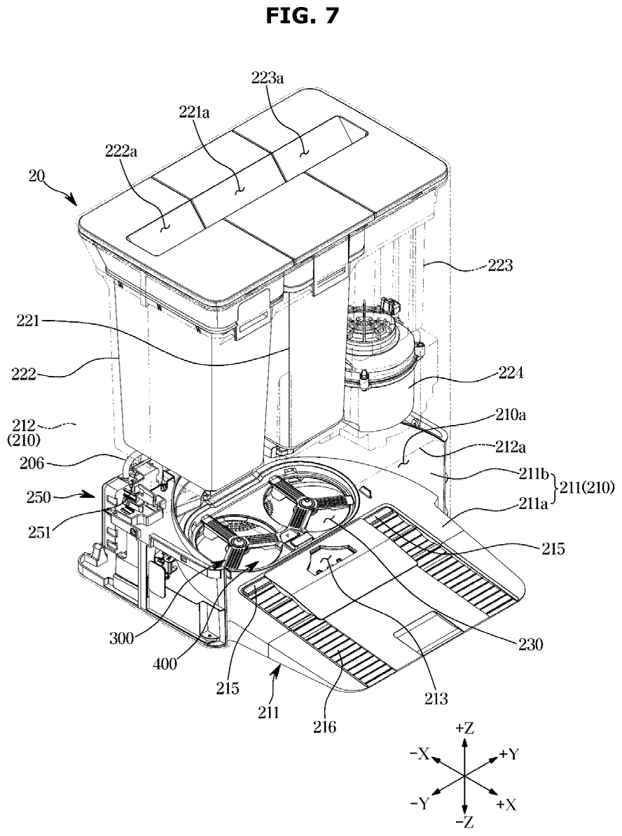

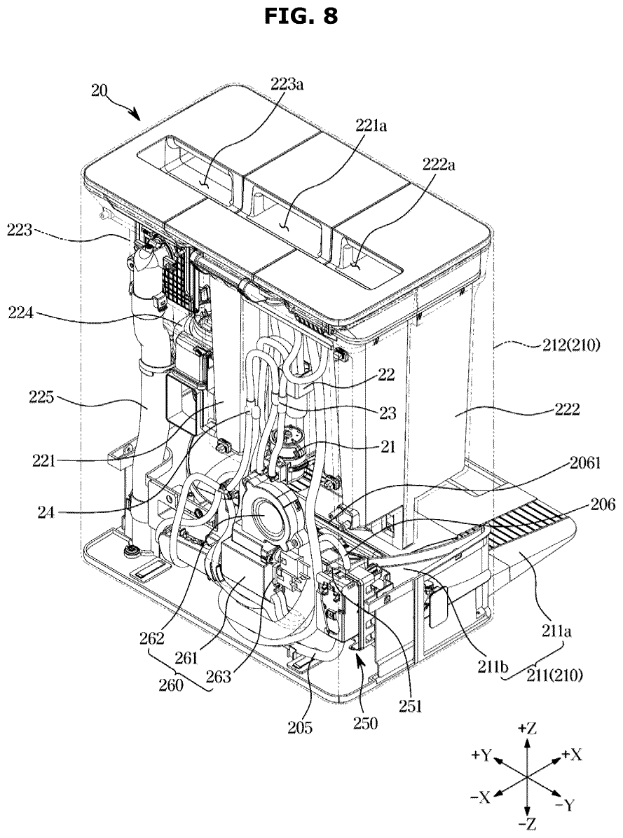

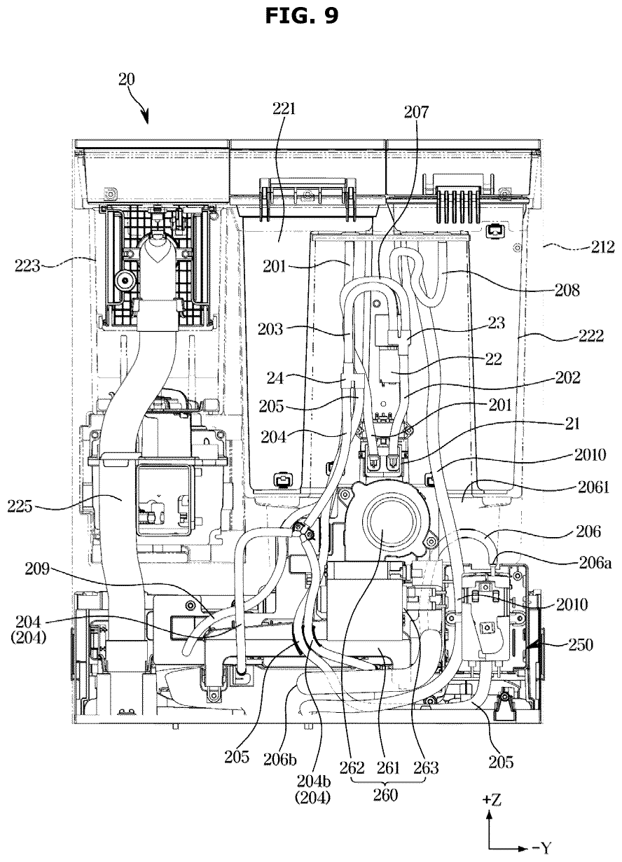

FIG. 7 is a view illustrating a station according to an embodiment. FIG. 8 is a view illustrating the rear of the station shown in FIG. 7. FIG. 9 is a rear view of the station shown in FIG. 7.

The station 20 may include a main body 210. The main body 210 may define the overall exterior appearance of the station 20. The main body 210 may form an accommodation space 210a to accommodate at least a part of the robot cleaner 10. The main body 210 may be referred to as station main body 210.

The main body 210 may include a base 211 and a housing 212 detachably coupled to the base 211.

The base 211 may include a cleaner seating portion 211a on which the robot cleaner 10 is mounted. The cleaner seating portion 211a may have an inclined shape from the surface to be cleaned to allow the robot cleaner 10 to enter. For example, the cleaner seating portion 211a may have an upwardly inclined shape along a direction in which the robot cleaner 10 enters the station 20. For example, the cleaner seating portion 211a may have an anti-slip portion 216 allowing the robot cleaner 10 to easily climb a slope of the cleaner seating portion 211a. For example, the cleaner seating portion 211a may have an anti-slip bump 215 formed to prevent the robot cleaner 10 seated on the station 20 from slipping along the slope of the cleaner seating portion 211a. The robot cleaner 10 seated on the station 20 may not deviate from the station 20 by the anti-slip bump 215.

The base 211 may include a side wall 211b extending upwards from the cleaner seating portion 211a. The side wall 211b may be provided to surround at least a part of the cleaner seating portion 211a.

The housing 212 may be provided to cover the side wall 211b of the base 211. The housing 212 may accommodate components of the station 20. Electric components may be disposed in the housing 212. The housing 212 may have an opening 212a, and the robot cleaner 10 may enter the accommodation space 210a of the station 20 through the opening 212a.

For example, the station 20 may be provided to receive water or wash water directly from an external water source. For example, the station 20 may include a water supply tank 221 detachably coupled to the main body 210 and containing water or wash water. Hereinafter, a station 20 including a water supply tank 221 will be described by way of example.

The station 20 may include the water supply tank 221. The water supply tank 221 is provided to store water. Relatively clean water may be contained in the water supply tank 221. Water stored in the water supply tank 221 may be supplied to the water tank 114 of the robot cleaner 10 or to a washing chamber 230 of the station 20 which will be described below. That is, water stored in the water supply tank 221 may be used for the purpose of supplying moisture to the wet mop 160 or washing the wet mop 160. The water supply tank 221 may be detachably mounted on the main body 210. For example, the user may separate the water supply tank 221 from the main body 210 or couple the water supply tank 221 to the main body 210 by grasping a handle 221a of the water supply tank 221.

The station 20 may include a wastewater tank 222. The wastewater tank 222 may be provided to store water. Relatively dirty water may be contained in the wastewater tank 222. After washing the wet mop 160, waste water may be stored in the wastewater tank 222. The wastewater tank 222 may be detachably mounted on the main body 210. For example, the user may separate wastewater tank 222 from the main body 210 or couple the wastewater tank 222 to the main body 210 by grasping a handle 222a of the wastewater tank 222.

The station 20 may include a dirt collection bin 223. The dirt collection bin 223 may be provided to store dirt collected from the dustbin 141 of the robot cleaner 10. The dirt collection bin 223 may be detachably mounted on the main body 210. For example, the user may separate the dirt collection bin 223 from the main body 210 or couple the dirt collection bin 223 to the main body 210 by grasping a handle 223a of the dirt collection bin 223.

Although the wastewater tank 222, the water supply tank 221, and the dirt collection bin 223 are sequentially aligned in an approximately horizontal direction (Y direction) in the drawings, the positions of the wastewater tank 222, the water supply tank 221, and the dirt collection bin 223 are not limited.

The station 20 may include an intake port 213. The intake port 213 may be formed at the cleaner seating portion 211a. While the robot cleaner 10 is seated on the station 20, the intake port 213 may communicate with the dustbin 141 of the robot cleaner 10. The intake port 213 may be provided to suck up dirt collected in the dustbin 141. The intake port 213 may be referred to as cleaner intake port 213.

The station 20 may include a dirt collection duct 225. The dirt collection duct 225 may be provided to guide dirt introduced through the intake port 213 toward the dirt collection bin 223. The dirt collection duct 225 may be disposed between the intake port 213 and the dirt collection bin 223. One end of the dirt collection duct 225 may communicate with the intake port 213. The other end of the dirt collection duct 225 may communicate with the dirt collection bin 223.

The station 20 may include an exhaust port 214 (See FIG. 3). The exhaust port 214 may be formed at the rear of the main body 210. The exhaust port 214 may be formed at the rear surface of the housing 212. The exhaust port 214 may discharge air, which is introduced into the station 20 and filtered, to the outside. For example, the exhaust port 214 may be provided in plural, and a plurality of exhaust ports 214 may be formed as a plurality of holes. The exhaust port 214 may be referred to as station exhaust port 214.

The station 20 may include an intake motor 224. In the case where the robot cleaner 10 is seated on the station 20, the intake motor 224 may generate suction power to suck dirt of the dustbin 141. By the suction power of the intake motor 224, dirt of the dustbin 141 may flow through the intake port 113 and along the dirt collection duct 225 to be collected in the dirt collection bin 223. By the suction power generated by the intake motor 224, the exhaust port 214 may discharge air, which is introduced into the station 20 and passes through an exhaust filter 226, to the outside. The intake motor 224 may be referred to as station intake motor 224.

The station 20 may include a steam generating device 250. The steam generating device 250 may generate steam. The steam generating device 250 may generate steam by using water stored in the water supply tank 221. The steam generating device 250 may receive water stored in the water supply tank 221 and generate steam.

The steam generating device 250 may be disposed below the water supply tank 221. The steam generating device 250 may include a steam chamber 251 capable of storing water received from the water supply tank 221.

The steam generating device 250 may include a heater 252 provided to heat water contained in the steam chamber 251. Water contained in the steam chamber 251 may be heated by a heater 252 to generate steam.

For example, the heater 252 may heat water by using vibration and/or electrical resistance. However, the present disclosure is not limited to the examples described above, and the type of the heater 252 is not limited as long as steam is generated by heating water.

The steam generating device 250 may include a steam chamber water level sensor (not shown) configured to detect a water level in the steam chamber 251. Upon detection of a predetermined water level by the steam chamber water level sensor, the heater 252 may operate. For example, detecting of the predetermined water level by the steam chamber water level sensor may include detecting that the water level in the steam chamber 251 reaches the predetermined level by the steam chamber water level sensor.

Accordingly, because the heater 252 operates only when the steam chamber 251 is filled with a certain amount of water, accidents such as fire may be prevented in advance.

The steam generating device 250 may further include a temperature sensor (not shown) configured to detect temperature inside the steam chamber 251. In the case where a temperature detected by the temperature sensor is higher than a preset temperature, the operation of the heater 252 may be stopped. Thus, because the operation of the heater 242 may be stopped at a too high temperature of steam, damage to the cleaning device (e.g., wet mop) may be prevented as well as accidents such as fire are prevented in advance.

The station 20 may include a drying device 260. The drying device 260 may be configured to generate air (hereinafter, referred to as dry air) to dry the wet mop 160. The drying device 260 may be configured to provide dry air to a washing chamber 230 to be described below. While the robot cleaner 10 is seated on the station 20, dry air discharged from the drying device 260 may flow toward the wet mop 160. The air generated in and provided by the drying device 260 may have a relatively low humidity or a relatively high temperature. The dry air may also be referred to as hot air or drying air.

For example, the station 20 may provide the wet mop 160 with dry air after washing and/or sterilizing the wet mop 160. For example, at a high moisture content of the wet mop 160 because the wet mop 160 wipes water on the surface to be cleaned while the robot cleaner 10 performs cleaning, the robot cleaner 10 may return to the station 20 and the station 20 may blow dry air toward the wet mop 160.

The drying device 260 may include a fan 262 generating a blowing force. The drying device 260 may include a drying duct 261 provided to guide air blown by the fan 262. The drying duct 261 may be provided to connect the fan 262 with the washing chamber 230 to be described below. The drying device 260 may include a heater 263 provided to heat the air blown by the fan 262. The heater 263 may be provided to heat air guided by the drying duct 261. At least a part of the heater 263 may be disposed in the drying duct 261.

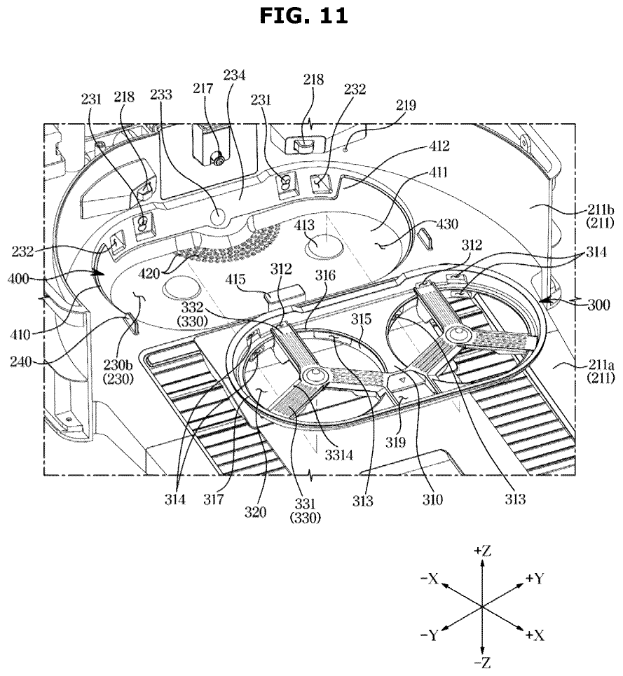

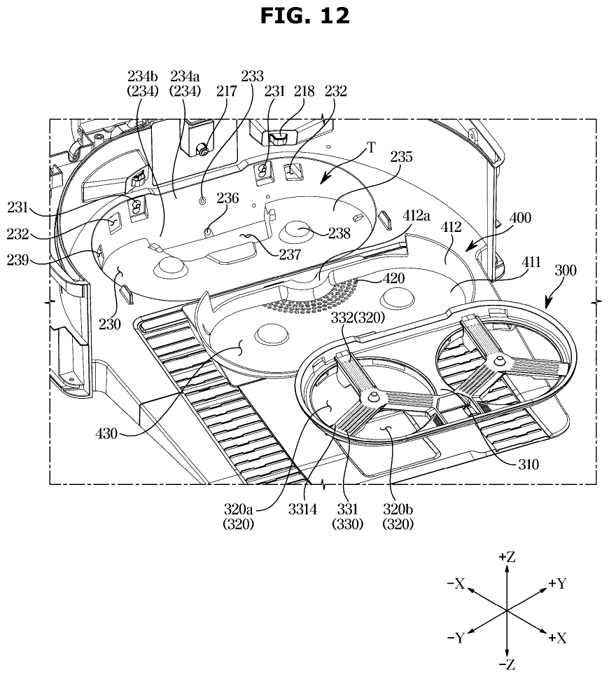

FIG. 10 is a partial view of a station according to an embodiment. FIG. 11 is a view illustrating a state where a wash frame is separated from a washing chamber in a station according to an embodiment. FIG. 12 is a state where a drainage frame is separated from the washing chamber in FIG. 11.

Referring to FIGS. 10 to 12, the station 20 may include a washing tank T in which components required for washing are seated or accommodated. For example, the washing tank T may be formed by recessing a partial region of the base 211. For example, the washing tank T may be formed by recessing a partial region of the cleaner seating portion 211a (described below) downwards (−Z).

The station 20 may include a washing chamber 230 to accommodate the wet mop 160. The washing chamber 230 may refer to a space where the wet mop 160 is washed. For example, the washing tank T may form the washing chamber 230. For example, the washing chamber 230 may refer to a region surrounded by the washing tank T recessed in the base 211. The washing chamber 230 may be provided to contain water received from the water supply tank 221. Water may be called or referred to as wash water. The washing chamber 230 may have a shape for containing wash water. While the robot cleaner 10 is seated on the station 20, the wet mop 160 may be washed by wash water contained in the washing chamber 230.

The station 20 may include a wash frame 300 and a drainage frame 400 to wash the wet mop 160. The wash frame 300 and the drainage frame 400 may be accommodated in the washing chamber 230.

For example, the wash frame 300 may be provided to be in contact with the wet mop 160. For example, in the case where the wet mop 160 is brought into contact with the wash frame 300, the wet mop 160 may be rotatable. Based thereon, the wash frame 300 may apply a frictional force to the wet mop 160, and dirt on the wet mop 160 may be removed.

For example, the drainage frame 400 may be provided to receive and drain waste produced by washing the wet mop 160. The drainage frame 400 may include a drainage housing 410 defining an exterior appearance and a receiving chamber 430, as a space surrounded by the drainage housing 410, to receive dirt.

In the case where dirt of the wet mop 160 is removed by the frictional force with the wash frame 300, the dirt may fall downwards by gravity. To receive the falling dirt, the drainage frame 400 may be located below the wash frame 300. The drainage frame 400 may be detachably mounted on the washing tank T. For example, the drainage frame 400 may be seated on the bottom 235 of the washing tank T.

For example, the drainage housing 410 may have a drainage frame bottom 411, and a drainage frame side wall 412 extending upwards from the drainage frame bottom 411. For example, the drainage frame side wall 412 may have a shorter length than the side wall 234 of the washing tank. For example, a volume of the receiving chamber 430 may be smaller than a volume of the washing chamber 230, but this is merely an example. The wash frame 300 and the drainage frame 400 will be described in more detail below.

While the robot cleaner 10 is mounted on the station 20, the washing chamber 230 may be provided to correspond to the wet mop 160.

The washing chamber 230 may be formed at the base 211 of the main body 210. The base 211 may be provided to supply wash water and steam to the washing chamber 230. For example, the base 211 may include the washing tank T. This will be described in detail later.

The washing chamber 230 may be provided to be recessed from the cleaner seating portion 211a.

As described above, the washing chamber 230 may be formed in the washing tank T. For example, the washing tank T may include a washing tank bottom 235 in which a dirt drain hole 236 through which dirt produced by washing the wet mop 160 is formed, and a washing tank T side wall extending upwards from the washing tank bottom 235.

For example, the washing tank T may include a waste storage groove 237 recessed downwards. The dirt storage groove 237 may be formed by recessing a part of the bottom 235 of the washing tank downwards to be lower than the other parts. For example, the dirt drain hole 236 may be disposed in the dirt storage groove 237.

For example, the washing tank T may include a second coupling member 238 extending upwards from the bottom 235 of the washing tank. As described later, the second coupling member 238 may be connected to a first coupling member 413 of the drainage frame 400 to allow the drainage frame 400 to be stably seated in the washing tank T.

In the case where the wash frame 300 is disposed in the washing chamber 230, the wash frame 300 may divide the washing chamber 230 into a first region 230a and a second region 230b other than the first region 230a (See FIG. 19). For example, the first region 230a may be an upper region of the washing chamber 230, and the second region 230b may be a lower region of the washing chamber 230, but the embodiment is not limited thereto. This will be described in detail later.

The side wall 234 of the washing tank may include a first side wall 234a corresponding to the first region 230a and facing the first region 230a. The side wall 234 of the washing tank may include a second side wall 234b corresponding to the second region 230b and disposed below the first side wall 234a to face the second region 230b.

The drainage frame 400 may include the first coupling member 413 protruding from the drainage frame bottom 411. The first coupling member 413 may accommodate the second coupling member 238 of the washing tank T. Based thereon, the first coupling member 413 may be coupled to the second coupling member 238, and the drainage frame 400 may be stably mounted in the washing tank T.

For example, the drainage frame 400 may be located in the second region 230b of the washing chamber 230. In other words, the drainage frame 400 may be located below the wash frame 300. Thereby, dirt falling from the wash frame 300 may be received.

The drainage frame 400 may include a drainage frame handle 415 extending upwards from the front center of the drainage frame bottom 411. The drainage frame handle 415 may be provided to be grasped by a user. To separate the drainage frame 400 from the washing chamber 230, the user may take the drainage frame 400 out via a process of grasping the drainage frame handle 415 and lifting the same upwards.

The drainage frame 400 may include a filtering hole 420 formed at the rear. For example, the filtering hole 420 may be formed at the rear center of the drainage frame bottom 411.

The filtering hole 420 may communicate with the dirt drain hole 236 of the washing tank T. The dirt falling from the wash frame 300 into the receiving chamber 430 may pass through the filtering hole 420. The dirt having passed through the filtering hole 420 may flow into the dirt drain hole 236 to be discharged out of the washing chamber 230.

For example, a diameter of the filtering hole 420 may be provided to be smaller than a diameter of the dirt drain hole 236. Therefore, because a size of dirt passing through the filtering hole 420 may be smaller than a size of the dirt drain hole 236, clogging of the dirt drain hole 236 may be prevented in advance. For example, the filtering hole 420 may have a plurality of filtering holes 420.

For example, in the case where the drainage frame 400 is accommodated in the washing chamber 230, the drainage frame bottom 411 may be disposed to have a downward slope in a direction where the robot cleaner 10 enters the station 20. For example, the drainage frame bottom 411 may be provided to be declined downwards toward the rear. Therefore, the dirt falling into the receiving chamber 430 from the wash frame 300 after washing of the wet mop 160 is completed may easily flow along the slope of the drainage frame bottom 411 toward the filtering hole 420. However, the present disclosure is not limited to the above-described example, the direction of the slope of the drainage frame bottom 411 and the position of the filtering hole 420 may vary according to the position of the dirt drain hole 236.

The station 20 may include the wash frame 300. The wash frame 300 may be provided to correspond to the washing chamber 230. The wash frame 300 may be located in the washing chamber 230. The wash frame 300 may be detachably coupled to the base 211. The wash frame 300 may be detachably mounted in the washing chamber 230. While the robot cleaner 10 is mounted on the station 20, the wash frame 300 may be provided to be in contact with the wet mop 160. While the robot cleaner 10 is mounted on the station 20, the wash frame 300 may be provided to rub the wet mop 160. The wet mop 160 may be washed while being rubbed with the wash frame 300. In this case, the wet mop 160 may be rotatably provided.

The wash frame 300 may include a frame body 310, a scraper 330 provided to scrape off dirt from the wet mop 160, and an opening 320. The frame body 310 may be detachably coupled to the side wall 234 of the washing tank. The opening 320 may be formed to penetrate the frame body 310. The scraper 330 may be formed at the frame body 310 to interfere with the wet mop 160.

As described above, in the case where the wash frame 300 is disposed in the washing chamber 230, the frame body 310 may divide the washing chamber 230 into the first region 230a and the second region 230b other than the first region 230a. For example, the first region 230a may refer to an upper region of the washing chamber 230, and the second region 230b may refer to a lower region of the washing chamber 230, but the embodiment is not limited thereto.

The opening 320 may be formed to penetrate the frame body 310 to connect the first region 230a with the second region 230b. For example, the opening 320 may be formed on each of the left and right sides of the frame body 310, but is not limited thereto, and may be provided in various ways depending on the number and location of the wet mop 160 corresponding to the wash frame 300.

For example, the scraper 330 may be formed to cross the opening 320. For example, the scraper 330 may be disposed in the opening 320.

The scraper 330 may be provided to apply friction to the wet mop 160 in contact with the wet mop 160. For example, in the case where the robot cleaner 10 is seated on the base 211 and the wet mop 160 is in contact with the wash frame 300, the robot cleaner 10 may rotate the wet mop 160 and the scraper 330 may rub with the wet mop 160, thereby washing the wet mop 160.

The scraper 330 may include a first scraper 331, and a second scraper 332 disposed to be spaced apart from the first scraper 331. For example, the first scraper 331 may be formed to protrude from one surface 316 of the front side of the frame body, but is not limited thereto. Although two first scrapers 331 are shown in the drawings, the number may vary and is not limited.

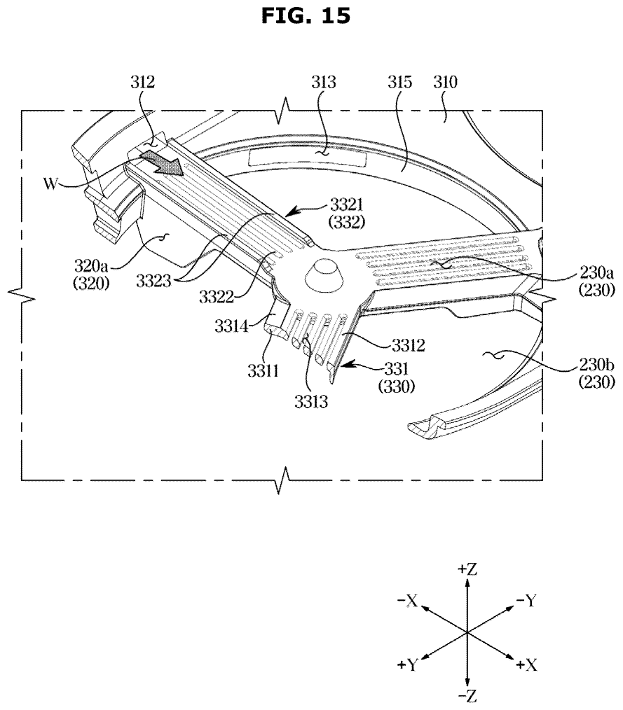

The first scraper 331 may include a first friction body (3311, See FIG. 15) protruding from one surface 316 of the frame body forming the rim of the opening 320. The first friction body 3311 may include a first friction surface 3312 (See FIG. 15) facing the first region 230a to be in contact with the wet mop 160. The first friction body 3311 may form an exterior appearance of the first scraper 331. The first friction surface 3312 may refer to an upper surface of the first friction body 3311. The first friction surface 3312 may be provided to apply friction to the wet mop 160.

For example, the first friction body 3311 may extend toward the center of the opening 320 to divide the opening into a first opening region 320a and a second opening region 320b spaced apart from the first opening region 320a. Assuming that the rotation direction of the wet mop 160 is a first direction, the first opening region 320a, the first friction body 3311, and the second opening region 320b may be sequentially arranged in the first direction.

For example, the first scraper 331 may include a guide rib 3314 provided to guide the lower surface of the wet mop 160 to the first friction surface 3312 while the wet mop 160 rotates. More specifically, the guide rib 3314 may extend to be inclined upwards in the first direction toward from the first opening region 320a toward the first friction surface 3312 to guide the lower surface of the wet mop 160 corresponding to the first opening region 320a onto the first friction surface 3312 while the wet mop 160 rotates in the first direction.

For example, the guide rib 3314 may be connected to one surface of the first friction surface 3312 facing the first opening region 320a. In other words, the guide rib 3314 may extend from one surface of the first friction surface 3312 facing the first opening region 320a.

Therefore, the wet mop 160 may move from the first opening region 320a onto the first friction surface 3312 more stably.

The scraper 330 may include the second scraper 332. The second scraper 332 may protrude from one surface 316 of the rear side of the frame body.

For example, the second scraper 332 may be provided to receive wash water sprayed from the wash water spray hole 312. For example, wash water may flow on the upper surface of the second scraper 332.

For example, the wash water spray hole 312 may communicate with an upper space of the second scraper 332. In other words, the upper surface of the second scraper 332 may extend from the one surface 316 of the frame body located below the wash water spray hole 312. Wash water having passed through the wash water spray hole 312 may be transferred to the upper surface of the second scraper 332 to flow in a lengthwise direction in which the second scraper 332 extends. Because the second scraper 332 is in contact with the wet mop 160, the wash water flowing on the upper surface of the second scraper 332 may be supplied to the wet mop 160.

The second scraper 332 will be described in detail later.

The station 20 may include the charging terminal 218. While the robot cleaner 10 is seated on the station 20, the charging terminal 218 of the station 20 may be electrically connected to the charging terminal 151 of the robot cleaner 10. Because the charging terminal 218 of the station 20 is electrically connected to the charging terminal 151 of the robot cleaner 10, the battery 150 of the robot cleaner 10 may be charged. That is, the robot cleaner 10 may be charged while being docked on the station 20. The charging terminal 218 may be referred to as station charging terminal 218.

The station 20 may include the water suppling port 217. Upon receiving the water stored in the water supply tank 221, the water suppling port 217 may supply water to the robot cleaner 10. While the robot cleaner 10 is mounted on the station 20, the water suppling port 217 of the station 20 may be connected to the water filling port 113 of the robot cleaner 10. Water flowing out of the water suppling port 217 may flow into the water filling port 113. Water flowing into the water filling port 113 may be stored in the water tank 114. In the case where the moisture content of the wet mop 160 decreases while the robot cleaner 1 performs cleaning, water stored in the water tank 114 may be provided to the wet mop 160. For example, the water suppling port 217 may be formed at the side wall 211b of the base 211 of the main body 210.

The station 20 may include a wash water supply nozzle 231. The wash water supply nozzle 231 may communicate with the washing chamber 230. The wash water supply nozzle 231 may receive water stored in the water supply tank 221 and supply the water to the washing chamber 230. Water discharged from the wash water supply nozzle 231 may be stored in the washing chamber 230. Water discharged from the wash water supply nozzle 231 may be used to wash the wet mop 160.

For example, the wash water supply nozzle 231 may be formed at the first side wall of the washing tank T. For example, the wash water supply nozzle 231 may be provided as a pair of wash water supply nozzles 231 symmetrically disposed on the first side wall of the washing tank. Although two wash water supply nozzles 231 are shown in the drawings, the number of the wash water supply nozzle 231 is not limited. For example, the number of the wash water supply nozzle 231 may correspond to the number of the wet mop 160.

The station 20 may include the wash water spray hole 312. More specifically, the wash frame 300 may include the wash water spray hole 312. For example, the wash water spray hole 312 may be formed at the frame body 310 to be open to connect the wash water supply nozzle 231 with the second friction surface 3322 (described below) of the second scraper 332.

The wash water spray hole 312 may be formed at the wash frame 300. While the wash frame 300 is mounted in the washing chamber 230, the wash water spray hole 312 may correspond to the wash water supply nozzle 231. The wash water spray hole 312 may communicate with the wash water supply nozzle 231. The wash water spray hole 312 may communicate with the washing chamber 230. The wash water spray hole 312 may receive water from the wash water supply nozzle 231 and spray the water toward the washing chamber 230. While the robot cleaner 10 is mounted on the station 20, the wash water spray hole 312 may spray water toward the wet mop 160. Although two wash water spray holes 312 are shown in the drawings, the number of the wash water spray hole 312 is not limited. For example, the number of the wash water spray hole 312 may correspond to the number of the wet mop 160.

For example, station 20 may include a washing chamber water level sensor 239. For example, the washing chamber water level sensor 239 may be disposed on the side wall 234 of the washing tank. The washing chamber water level sensor 239 may be provided to detect the water level of wash water/wastewater contained in the washing chamber 230 in accordance with washing of the wet mop 160. At a water level of the washing chamber 230, which is detected by the washing chamber water level sensor 239, higher than a certain level, the wash water supply nozzle 231 may be controlled to stop the spraying of wash water.

The station 20 may include a dry air supplier 232. The dry air supplier 232 may communicate with the washing chamber 230. The dry air supplier 232 may receive dry air from the drying device 260 and supply the dry air to the washing chamber 230. Dry air received from the drying device 260 may be supplied to the washing chamber 230 through the dry air supplier 232. For example, the dry air supplier 232 may be formed on the side wall 234 of the washing tank. For example, the dry air supplier 232 may be formed to cross the first side wall 234a and the second side wall 234b of the washing tank T. Therefore, dry air received from the dry air supplier 232 may be sprayed to the first region 230a and the second region 230b of the washing chamber 230.

Although two dry air suppliers 232 are shown in the drawings, the number of the dry air supplier 232 is not limited. For example, the number of the dry air supplier 232 may correspond to the number of the wet mop 160.

The station 20 may include a dry air spray hole 314. The wash frame 300 may include a dry air spray hole 315. The dry air spray hole 314 may be formed at the wash frame 300.

While the wash frame 300 is mounted in the washing chamber 230, the dry air spray hole 314 may correspond to the dry air supplier 232. The dry air spray hole 314 may communicate with the dry air supplier 232.

More specifically, the dry air spray hole 314 may be formed at the rear of the frame body 310. The dry air spray hole 314 may be located at the frame body 310 to correspond to the dry air supplier 232. The dry air spray hole 314 may be open toward the rear of the frame body 310 to receive dry air from the dry air supplier 232.

The dry air spray hole 314 may communicate with the washing chamber 230. The dry air spray hole 314 may receive dry air from the dry air supplier 232 and spray the dry air toward the washing chamber 230.

While the robot cleaner 10 is mounted on the station 20, the dry air spray hole 314 may spray dry air toward the wet mop 160. Although two vertically arranged dry air spray holes 314 corresponding to one dry air supplier 232 are shown in the drawings, the present disclosure is not limited thereto. The shape and/or position of the dry air spray hole 314 are not limited.

The station 20 may include a steam supplier 233. The steam supplier 233 may communicate with the washing chamber 230. For example, the steam supplier 233 may be formed on the side wall 234 of the washing tank. For example, the steam supplier 233 may be formed on the second side wall 234b of the washing tank, but is not limited thereto.

The steam supplier 233 may receive steam from the steam generating device 250 and supply the steam to the washing chamber 230. The steam generated in the steam generating device 250 may be discharged to the washing chamber 230 through the steam supplier 233.

For example, the wash frame 300 communicating with the steam supplier 233 may receive steam and spray the steam to the wet mop 160. This will be described in detail later.

Although one steam supplier 233 is shown in the drawings, the number of the steam supplier 233 is not limited. For example, the steam supplier 233 may be provided in plural.

The station 20 may include a steam spray hole 313. The steam spray hole 313 may be formed at the wash frame 300. While the wash frame 300 is mounted in the washing chamber 230, the steam spray hole 313 may correspond to the steam supplier 233. The steam spray hole 313 may communicate with the steam supplier 233. The steam spray hole 313 may communicate with the washing chamber 230. The steam spray hole 313 may receive steam from the steam supplier 233 and spray the steam toward the washing chamber 230. While the robot cleaner 10 is mounted on the station 20, the steam spray hole 313 may spray steam toward the wet mop 160. Although two steam spray holes 313 are shown in the drawings, the number of the steam spray hole 313 is not limited. For example, the number of the steam spray hole 313 may correspond to the number of the wet mop 160.

The station 20 may include the dirt drain hole 236. The drain hole 236 may communicate with the washing chamber 230. The dirt drain hole 236 may be provided to collect wastewater contained in the washing chamber 230. The dirt drain hole 236 may be provided to guide wastewater contained in the washing chamber 230.

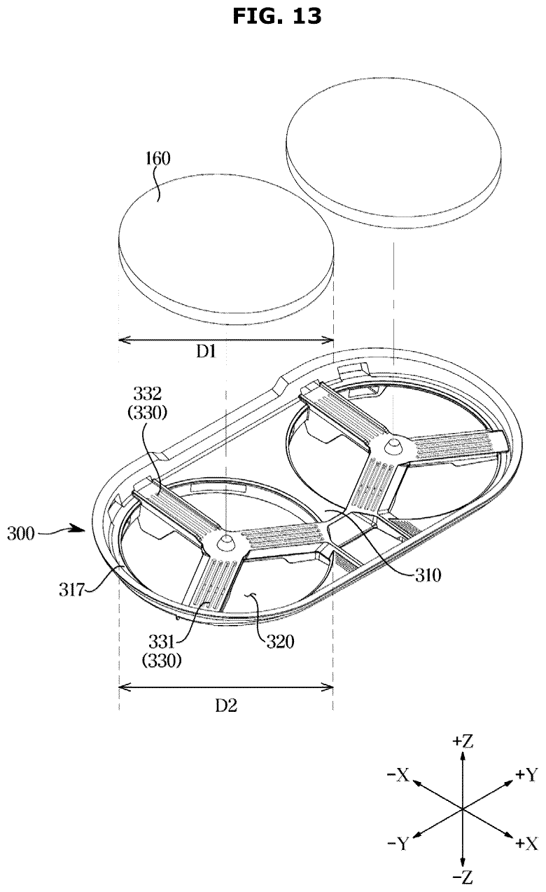

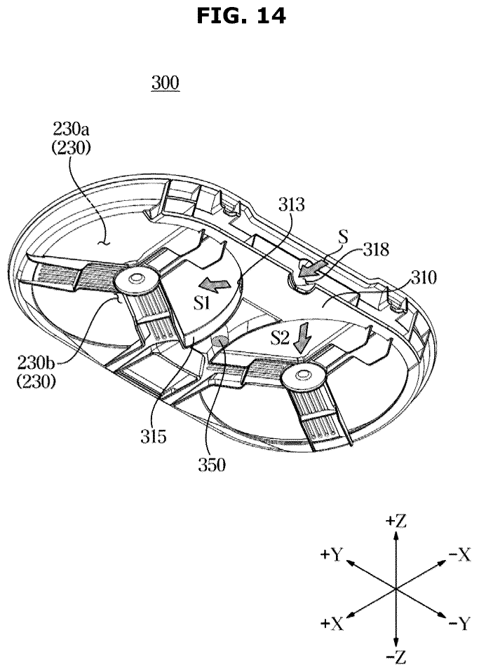

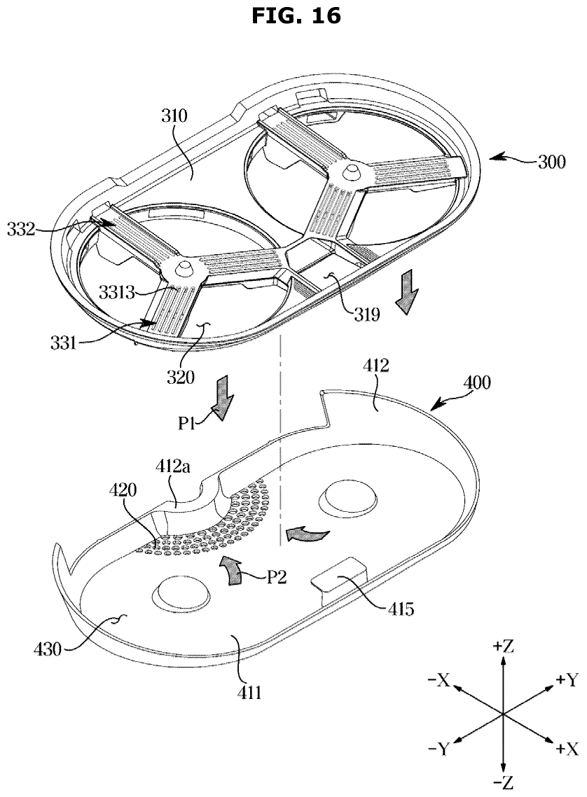

FIG. 13 is a view illustrating that a wash frame is separated from a wet mop in a cleaning device according to an embodiment. FIG. 14 is a view of a wash frame in a cleaning device according to an embodiment viewed from a different angle. FIG. 15 is an enlarged view of a partial cross-section of a cleaning device according to an embodiment. FIG. 16 is a view illustrating that a wash frame is separated from a drainage frame in a cleaning device according to an embodiment.

Referring to FIGS. 13 to 16, the wash frame 300 may include a steam inlet 318 formed at the rear of the frame body 310 and allowing steam to flow in, and a steam spray hole 313 provided to discharge the steam forward.

The steam inlet 318 may communicate with the steam spray hole 313. In the case where the wash frame 300 is accommodated in the washing chamber 230, the steam inlet 318 may communicate with the steam supplier 233 (See FIG. 11) formed at the washing tank T. Therefore, steam supplied by the steam supplier 233 may flow into the wash frame 300 through the steam inlet 318 and then be discharged through the steam spray hole 313.

The wash frame 300 may include an extension 315 extending downwards from a part of the frame body forming the rim of the opening 320. That is, the extension 315 may be disposed in the second region 230b. The extension 315 may be provided as a hollow cavity. The inside of the extension 315 may communicate with the steam inlet 318.

The steam spray hole 313 may be formed in one surface of the extension 315 facing forward. That is, the steam spray hole 313 may be located in the second region 230b. Therefore, steam discharged from the steam spray hole 313 may flow in the second region 230b. As will be described later, because the opening 230 is covered with the wet mop 160, steam does not leak out through the opening 230 but is in contact with the lower surface of the wet mop 160 for a long time. Thus, sterilization of the wet mop 160 by steam may be conducted more effectively.

The wash frame 300 may include a wet mop support 317 on which the wet mop 160 is seated, as a part of the frame body 310 formed along the rim of the opening 320. The wet mop support 317 may extend in a radial direction of the opening 320.

For example, a radius of the wet mop support 317 may correspond to a radius of the wet mop 160. Thus, the wet mop 160 may be stably seated on the wet mop support 317.

For example, a diameter D2 of the opening 320 may be smaller than a diameter D1 of the wet mop 160. In other words, once the wet mop 160 is disposed in the first region 230a to be seated on the wash frame 300 in contact with wet mop support 317, the opening 320 may be covered with the wet mop 160. In the case where the wet mop 160 is seated on the wash frame 300, the opening 320 may be closed by the wet mop 160. In the case where the wet mop 160 is seated on the wash frame 300, the first region 230a may be separated from the second region 230b.

Therefore, steam sprayed into the second region 230b through the steam spray hole 313 may stay in the second region 230b to be continuously in contact with the lower surface of the wet mop 160 without flowing into the first region 230a. Therefore, the wet mop 160 may be sterilized more effectively.

The wash frame 300 may include a through-hole 3313. The through-hole 3313 may be formed in the first scraper 331. The through-hole 3313 may be formed to penetrate the first friction body 3311. The through-hole 3313 may be formed to penetrate the first friction surface 3312. The through-hole 3313 may allow the first region 230a to communicate with the second region 230b. The through-hole 3313 may be formed to penetrate the first scraper 331 in the vertical direction.

For example, the through-hole 3313 may have an approximate slit shape extending in a direction where the first friction body 3311 extends. For example, the through-hole 3313 may have a plurality of through-holes 3313 aligned in a direction intersecting the direction where the first friction body 3311 extends. For example, because the through-hole 3313 is formed to penetrate the first friction surface 3312, the first friction surface 3312 may be separated to include at least one region.

Upon application friction to the wet mop 160 by the first scraper 331, dirt may be separated from the wet mop 160. Because the first scraper 331 has the through-holes 3313, the separated dirt is not accumulated on the first friction surface 3312, but falls into the second region 230b through the through-holes 3313 to be stored in the drainage frame 400. Thus, the wash frame 300 may be managed in a cleaner state.

For example, in the case where the wet mop 160 is seated on the wash frame 300, the wet mop 160 may be in contact with the second scraper 332.

The second scraper 332 may include a second friction body 3321 protruding from another surface of the frame body 310 forming the rim of the opening 230. The second scraper 332 may have a second friction surface 3322 that may be in contact with the wet mop 160 as a surface of the second friction body 3321 facing the first region 230a.

For example, the first friction body 3311 and the second friction body 3321 may respectively extend from one surface 316 of the frame body forming the rim of the opening 230, respectively, to be connected with each other at the center of the opening 230.

The upper space of the second friction surface 3322 may communicate with the wash water spray hole 313. In other words, wash water sprayed through the wash water spray hole 313 may be transferred onto the second friction surface 3322. Wash water transferred to the second friction surface 3322 may flow in a direction where the second friction surface 3322 extends. Therefore, wash water may be more effectively supplied to the wet mop 160 seated on the second scraper 332.

The second scraper 332 may include a wash water guide wall 3323 provided to guide the flow of wash water. For example, the wash water guide wall 3323 may include a pair of wash water guide walls 3323.

The wash water guide wall 3323 may protrude toward the first region 230a from the second friction surface 3322. The wash water guide walls 3323 may extend in a direction where the second friction surface 3322 extends. A pair of wash water guide walls 3323 may be formed at opposite ends of the second friction surface 3322 in a direction intersecting the lengthwise direction of the second friction surface 3322. A pair of wash water guide walls 3323 may be formed at both opposite ends of the second friction surface 3322 adjacent to the opening 320, respectively.

For example, because the wash water guide walls 3323 protrude from the second friction surface 3322 toward the first region 230a, dirt of the wet mop 160 may be removed more effectively.

Wash water may flow into a space formed by the pair of wash water guide walls 3323 and the second friction surface 3322. Therefore, the wash water may stably flow on the second friction surface 3322 without leaking through the opening 320 to be transferred to the wet mop 160.

For example, the second friction body 3321 may not have through-holes formed in the vertical direction, but is not limited thereto.

In the case where the wet mop 160 is brought into contact with the second scraper 332, the second scraper 332 may be provided to rub the wet mop 160. More specifically, in the process of washing the wet mop 160 of the robot cleaner 10 mounted on the station 20, the wet mop 160 seated on the wash frame 300 may be provided to rotate. Thereby, the second friction surface 3322 rubs the lower surface of the wet mop 160 to remove dirt, and the like of the wet mop 160.

For example, the wash frame 300 and the drainage frame 400 may be detachably coupled to each other, but the wash frame 300 and the drainage frame 400 may also be integrated with each other. Hereinafter, a case in which the wash frame 300 and the drainage frame 400 detachably coupled to each other will be described by way of example.

The drainage frame 400 may include a drainage frame top 412a. In the case where the drainage frame 400 is coupled with the wash frame 300, the frame body 310 of the wash frame 300 may be seated on and supported by the drainage frame top 412a.

For example, the wash frame 300 may include a handle insertion hole 319. In the case where the wash frame 300 is coupled with the drainage frame 400, the handle 415 of the drainage frame 400 may be inserted into the handle insertion hole 319 of the wash frame 300. Therefore, the handle 415 of the drainage frame 400 may penetrate the frame body 310 of the wash frame 300 to extend upwards.

Thus, the user may easily grasp the handle 415 of the drainage frame 400, and the wash frame 300 may also be lifted by lifting the drainage frame 400 by grasping the handle 415, so that the wash frame 300 and the drainage frame 400 may be easily separated from the washing chamber 230.

For example, the wash frame 300 may include a magnetic member 350 mounted on the lower surface of the frame body 310. For example, the station 20 may include a magnetic detection sensor (not shown) disposed under the bottom 235 of the washing tank. The magnetic detection sensor may detect the approach of the magnetic member 350 by interacting with the magnetic member 350. For example, the approach of the magnetic member 350 refers to a state where the wash frame 300 is mounted in the washing tank T and disposed in the washing chamber 230.

In the case where the wash frame 300 is disposed in the washing chamber 230, the magnetic detection sensor may determine whether the magnetic member 350 approaches. That is, the presence of the wash frame 300 in the washing chamber 230 may be determined.

For example, in the case where the approach of the magnetic member 350 is not detected by the magnetic detection sensor, wash water may not be sprayed from the wash water supply nozzle 231. For example, in the case where the approach of the magnetic member 350 of the magnetic detection sensor is not detected by the magnetic member 350, steam may not be sprayed from the steam supplier 233.

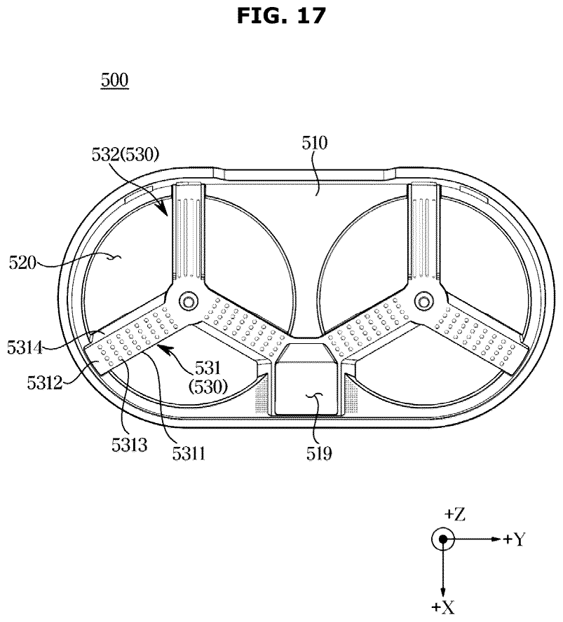

FIG. 17 is a view illustrating a wash frame in a cleaning device according to an embodiment.

Referring to FIG. 17, a first scraper 530 may have a plurality of through-holes 5313. The plurality of through-holes 5313 may be formed to penetrate the first friction body 5311. The plurality of through-holes 5313 may be formed to penetrate the first friction surface 5312. The plurality of through-holes 5313 may be arranged along a direction where the first friction body 5311 extends.

Although a plurality of through-holes 5313 with a circular shape are illustrated in the drawings, this is merely an example, and the plurality of through-holes 5313 may be formed to have various shapes such as slits and circular holes.

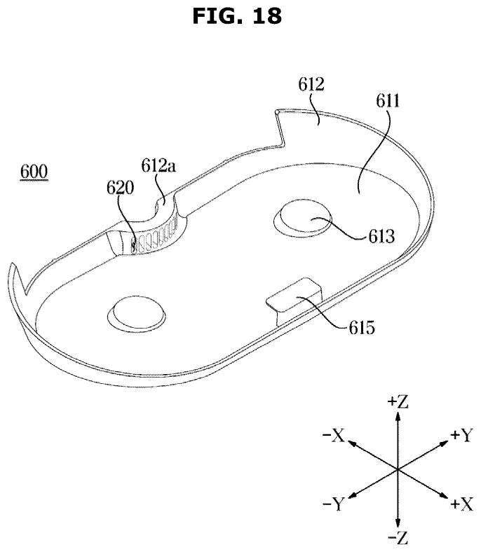

FIG. 18 is a view illustrating a drainage frame in a cleaning device according to an embodiment.

Referring to FIG. 18, the drainage frame 600 may have a filtering hole 620. For example, the filtering hole 620 may have a slit shape extending in the vertical direction, but is not limited thereto. For example, the filtering hole 620 may be formed in a side wall 612 of the drainage frame. For example, the filtering hole 620 may be formed at the center of the rear side wall 612. The filtering hole 620 may have a plurality of filtering holes 620.

The filtering hole 620 may communicate with the dirt drain hole 236. For example, a diameter of the filtering hole 620 in the horizontal direction may be smaller than a diameter of the dirt drain hole 236 in the horizontal direction. Therefore, a phenomenon wherein dirt with a greater diameter than that of the filtering hole 620 flows into the dirt drain hole 236 may be prevented, and thus clogging of the dirt drain hole 236 may be prevented.

The shape of the filtering hole 620 is only an example, and the size, shape, and number of the filtering hole 620 may vary.

FIG. 19 is a cross-sectional view taken along line A-A′ of FIG. 3. FIG. 20 is a cross-sectional view taken along line B-B′ of FIG. 3.

Referring to FIGS. 19 and 20, the robot cleaner 10 may be mounted on the station 20. As described above, in a state where the robot cleaner 10 is mounted on the station 20, the wet mop 160 may be provided to correspond to the washing chamber 230 of the station 20. While the robot cleaner 10 is mounted on the station 20, the wet mop 160 may be sterilized by steam discharged from the station 20.

While being sterilized by steam, the wet mop 160 may be provided to rotate. Thereby, steam may reach the entire wet mop 160.

A steam pipe 206 may be provided to guide steam generated by the steam generating device 250 to the washing chamber 230. One end of the steam pipe 206 may be connected to the steam generating device 250, and the other end 206b of the steam supplier 233 may be connected to the steam supplier 233.

The steam spray hole 313 of the wash frame 300 may be disposed to correspond to the steam supplier 233. The steam spray hole 313 may be provided to spray the steam guided to the washing chamber 230 via the steam pipe 206 toward the wet mop 160.

For example, while the robot cleaner 10 is mounted on the station 20, at least a part of the steam spray hole 313 may be disposed below the lower surface of the wet mop 160. In other words, at least a part of the steam spray hole 313 may be provided to discharge steam into the second region 230b.

Steam sprayed from the steam spray hole 313 may reach the lower surface of the wet mop 160. At least a part of the steam sprayed from the steam spray hole 313 move upwards to reach the lower surface of the wet mop wet mop 160. Thereby, steam may be intensively sprayed onto the lower surface of the wet mop 160 directly contacting the surface to be cleaned. That is, steam may be intensively supplied to the lower surface of the wet mop 160 where sterilization is most necessary.

For example, a size of the other end 206b of the steam pipe 206 may be greater than a size of the steam spray hole 313. For example, a width of the other end 206b of the steam pipe 206 in the vertical direction (Z direction) may be greater than a width of the steam spray hole 313 in the vertical direction (Z direction). Accordingly, steam flows from the steam pipe 206 to the steam spray hole 313 having a relatively smaller size than that of the steam pipe 206, and thus the speed of the stream may increase. Thus, steam may be sprayed farther at a relatively high speed through the steam spray hole 313. The steam sprayed through the steam spray hole 313 may easily arrive at the wet mop 160.

Because a wet mop of a robot cleaner is generally wet, it is easy for bacteria to grow thereon. In the case where bacteria grow on the wet mop with dirt thereon, an unpleasant odor may be caused by the wet mop, and the surface to be cleaned may be secondarily contaminated due to the wet mop. In addition, bacteria that have grown on the wet mop may affect respiratory health of a user and cause discomfort to the user. Thus, cleaning efficiency and user convenience of the cleaning device may decrease.

On the contrary, according to the present disclosure, the station 20 may spray steam to sterilize the wet mop 160 of the robot cleaner 10. Steam may prevent the growth of bacteria, or the like on the wet mop 160. Therefore, occurrence of unpleasant odor in the wet mop 160 and secondary contamination of the surface to be cleaned may be prevented. Because the wet mop 160 is kept clean, the wet mop 160 may be easily managed. In addition, in the case where the moisture content of the wet mop 160 decreases while the robot cleaner 10 performs cleaning, the robot cleaner 10 may return to the station 20, and the station 20 may spray steam toward the wet mop 160 of the robot cleaner 10. That is, steam may be used not only to sterilize the wet mop 160 but also to provide moisture to the wet mop 160. For example, in the case where a region to be cleaned is small, the station 20 may spray steam to the wet mop 160. Therefore, the wet mop 160 may easily and quickly receive moisture. As a result, cleaning efficiency and user convenience of the cleaning device 1 may increase.

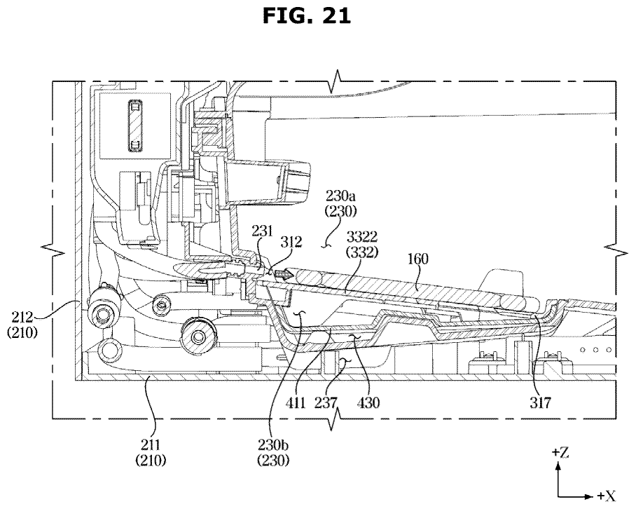

FIG. 21 is a cross-sectional view taken along line C-C′ of FIG. 3 in which the robot cleaner is removed and the wet mop is disposed.

Referring to FIG. 21, wash water is sprayed through the wash water supply nozzle 231 and transferred to the wet mop 160 via the wash water spray hole 312. The wash water supply nozzle 231 may communicate with the wash water spray hole 312.

As described above, the cleaner seating portion 211a may be formed to be inclined upwards in a direction where the robot cleaner 10 enters the station 20. For example, the wash frame 300 may be disposed to be inclined upwards in the direction where the robot cleaner 10 enters the station 20 in accordance with the cleaner seating portion 211a.

For example, the wash water supply nozzle 231 may be provided to spray wash water horizontally toward the wash frame 300 disposed to be inclined. In other words, the wash water supply nozzle 231 may be disposed to be inclined to correspond to the slope of the wash frame 300. The wash water supply nozzle 231 may be formed to be inclined upwards along the direction where the robot cleaner 10 enters the station 20. The wash water supply nozzle 231 may be disposed to be inclined to spray wash water parallel to the direction where the wash frame 300 extends in a forward-backward direction. The wash water supply nozzle 231 may be disposed to be inclined parallel to the radial direction of the wet mop 160 seated on the wash frame 300. Therefore, wash water may be sprayed to the wet mop 160 more effectively.

The arrangement of the wash water supply nozzle 231 is merely an example and the wash water supply nozzle 231, and the arrangement of the wash water supply nozzle 231 may vary according to environments and purposes of use.

The station 20 according to the present disclosure includes a base 211 including a washing chamber 230 corresponding to a wet mop 160 in the case where a robot cleaner 10 including the wet mop 160 is mounted thereon and configured to supply wash water and steam to the washing chamber 230 and a wash frame 300 detachably coupled to the base 211 and disposed in the washing chamber 230 to be in contact with the wet mop 160. The wash frame 300 includes a frame body 310 dividing the washing chamber 230 into a first region 230a and a second region 230b other than the first region 230a, an opening 320 formed to penetrate the frame body 310 to connect the first region 230a to the second region 230b, and a scraper 330 formed to cross the opening 320 and configured to apply friction to the wet mop 160, wherein the scraper 330 includes a first scraper 331 having a through-hole 3313 connecting the first region 230a to the second region 230b, and a second scraper 332 disposed to be spaced apart from the first scraper 331 and configured to receive the wash water.

The first scraper 331 may further include a first friction body 3311 protruding from one surface of the frame body 310 forming the rim of the opening 320 and having a first friction surface 3312 facing the first region 230a to be in contact with the wet mop 160. The through-hole 3313 may be formed to penetrate the first friction body 3311.

The first friction body 3311 may extend toward the center of the opening 320 to divide the opening into a first opening region 320a and a second opening region 320b spaced apart from the first opening region 320a, and the first opening region 320a, the first friction body 3311, and the second opening region 320b may be sequentially arranged in a first direction where the wet mop 160 rotates.

The first scraper 331 may further include a guide rib 3314 extending to be inclined upwards with respect to the first direction from the first opening region 320a toward the first friction surface 3312 to guide the lower surface of the wet mop 160 corresponding to the first opening region 320a to the first friction surface 3312 while the wet mop 160 rotates in the first direction.

The guide rib 3314 may be connected to one surface of the first friction surface 3312 facing the first opening region 320a.

The second scraper 332 may include a second friction body 3321 protruding from another surface of a frame body 310 forming the rim of the opening 320, and having a second friction surface 3322 facing the first region 230a to allow wash water to flow.

The base 211 may further include a washing tank T including a wash water supply nozzle 231 formed at the first side wall of the washing tank T facing the first region 230a, the washing tank T forming the washing chamber 230. The wash frame 300 may further include a wash water spray hole 312 open at the frame body 210 to connect the wash water supply nozzle 231 with the second friction surface 3322.

The second friction body 3321 may include a pair of wash water guide walls 3323 protruding from the second friction surface 3322 along a lengthwise direction of the second friction body 3321.

The wash water supply nozzle 231 may be disposed to be inclined in a direction corresponding to the direction where the second friction surface 3322 extends.

The washing tank T may further include a steam supplier 233 formed on a second side wall of the washing tank T facing the second region 230b, and the wash frame 300 may include a steam inlet 310 communicating with the steam supplier 233 and a steam spray hole 313 communicating with the steam inlet 318 and formed at the extension 315 extending from the frame body 310 forming the rim of the opening 320 toward the second region 230b to discharge steam.

The washing tank T may further include a dry air supplier 232 formed on the first side wall and the second side wall of the washing tank T to spray drying air toward the first region 230a and the second region 230b, and the wash frame 300 may further include a dry air spray hole 314 open at the frame body 310 to correspond to the dry air supplier 232.

A diameter D2 of the opening 320 may be smaller than a diameter D1 of the wet mop 160.

The frame body 310 may further include a wet mop support 317 formed along the rim of the opening 320 and extending in a radial direction of the opening 320 to support the wet mop 160.

The station 20 may further include a drainage frame 400 accommodated in the washing chamber 230 and detachably coupled to the wash frame 300, wherein the drainage frame 400 may be disposed in the second region 230b to accommodate dirt falling from the wash frame 300.

The drainage frame 400 may further include a filtering hole 400 communicating with the dirt drain hole 236 to transfer the accommodated dirt to the dirt drain hole 236 formed at the bottom of the washing tank T constituting the washing chamber 230, and a diameter of the filtering hole 400 may be formed to be smaller than a diameter of the dirt drain hole 236.

The cleaning device 1 according to the present disclosure includes a robot cleaner 10 including a cleaner main body 110 and a wet mop 160 detachably coupled to the cleaner main body 110 and rotatable and a station 20 configured to be mounted with the robot cleaner 10. The station 20 may include a base 211 including a washing chamber 230 corresponding to the wet mop 160 in the case where the robot cleaner 10 is mounted thereon and configured to supply wash water to the washing chamber 230 and a wash frame 300 disposed in the washing chamber 230 to allow the wet mop 160 to be seated thereon. The wash frame 300 includes a frame body 310 dividing the washing chamber 230 into a first region 230a and a second region 230b other than the first region 230a, an opening 320 formed to penetrate the frame body 310 to allow the first region 230a to communicate with the second region 230b and covered with the wet mop 160, a first scraper 331 disposed in the opening 320 and including a first friction body 3311 having a first friction surface 3312 configured to rub the wet mop 160 and a through-hole 3313 formed to penetrate the first friction body 3311, and a second scraper 332 disposed in the opening 320 to be spaced apart from the first scraper 331 and including a second friction body 3321 to receive the wash water.

The first friction body 3311 divides the opening 320 into a first opening region 320a and a second opening region 320b spaced apart from the first opening region 320a, and the first opening region 320a, the first friction body 3311, and the second opening region 320b are sequentially aligned in a first direction where the wet mop 160 rotates, and the first scraper 331 may further include a guide rib 3314 extending to be inclined upwards in the first direction from the first opening region 320a toward the first friction surface 3312.

The second scraper 332 may include the second friction body 3321 having the second friction surface 3322 facing the first region 230a to allow the wash water to flow, and the second friction body 3321 may include a pair of wash water guide walls 3323 protruding from the second friction surface 3322 in the lengthwise direction of the second friction body 3321.

The diameter D2 of the opening 320 may be smaller than the diameter D1 of the wet mop 160, and the frame body 310 may further include the wet mop support 317 formed along the rim of the opening 320 and extending in a radial direction of the opening 320, thereby supporting the wet mop 160.

The cleaning device 1 according to the present disclosure includes a robot cleaner 10 including a cleaner main body 110 and a wet mop 160 detachably coupled to the cleaner main body 110 and a station 20 mounted with the robot cleaner 10 and configured to wash the wet mop 160. The station 20 includes a washing chamber 230 corresponding to the wet mop 160 in the case where the robot cleaner 10 is mounted, and a wash frame 300 disposed in the washing chamber 230 and allowing the wet mop 160 to be seated thereon. The wash frame 300 may include a frame body 310 allowing the wet mop 160 to be seated thereon, an opening 320 penetrating the frame body 310 in the vertical direction, a first scraper 331 disposed in the opening 320 and including a first friction body 3311 rubbing the wet mop 160 and a through-hole 3313 penetrating the first friction body 3311 in the vertical direction, and a second scraper 332 disposed in the opening 320 and provided to receive wash water and supply wash water to the wet mop 160.

According to the present disclosure, while the robot cleaner is mounted on the station, the wet mop may be washed by being accommodated in the washing chamber and seated on the wash frame, and thus the wet mop may be managed more conveniently.

According to the present disclosure, the dirt may fall onto the drainage frame through the through-hole, and thus accumulation of dirt on the first scraper may be prevented.

According to the present disclosure, the wash water guide walls are formed on the second scraper, and thus wash water may be transferred to the wet mop more effectively.

According to the present disclosure, the wet mop may be washed using wash water and steam and then dried, and thus the wet mop may be maintained and managed clean.

According to the present disclosure, the opening of the wash frame is smaller than the diameter of the wet mop, and thus steam flowing below the wash frame may not flow into the upper area of the wash frame, and thus the wet mop may be sterilized more effectively.

However, the effects obtainable by the present disclosure are not limited to the aforementioned effects, and any other effects not mentioned herein will be clearly understood from the following description by those skilled in the art to which the present disclosure pertains.

Although the embodiments of the present disclosure have been provided for illustrative purposes, the scope of the present disclosure is limited thereto. Various embodiments that may be modified and altered by those skilled in the art without departing from the principles and spirit of the present disclosure, the scope of which is defined in the claims, should be construed as falling within the scope of the present disclosure.

1. A station to which a robot cleaner is dockable, the robot cleaner including a wettable mop that is rotatable by the robot cleaner to wipe dirt from a surface to be cleaned, the station comprising:
a tank configured to store water;
a washing chamber; and
a wash frame in the washing chamber and including:
a frame body dividing the washing chamber into a first region and a second region,
an opening penetrating the frame body and connecting the first region to the second region, and
a scraper crossing the opening and including:
a first scraper having a through-hole connecting the first region to the second region, and
a second scraper spaced apart from the first scraper and configured to receive water stored in the tank,
wherein the station is configured so that,
with the robot cleaner docked to the station,
the wettable mop is accommodable in the first region of the washing chamber, and
with the wettable mop accommodated in the first region and rotated by the robot cleaner, water received by the second scraper is supplied to the wettable mop to wet the wettable mop and frictional forces are applied to the wettable mop by the first scraper and the second scraper so as to remove dirt from the wettable mop through the opening and the through-hole to the second region.

2. The station of claim 1, wherein
the frame body forms a rim of the opening,
the first scraper includes a friction body protruding from a surface of the frame body and having a friction surface facing the first region,
the through-hole penetrates the friction body, and
the first scraper is configured so that, with the robot cleaner docked to the station and with the wettable mop accommodated in the first region, the friction surface contacts the wettable mop.

3. The station of claim 2, wherein
the friction body extends toward a center of the opening and divides the opening into a first opening region and a second opening region spaced apart from the first opening region, and
the first opening region, the friction body, and the second opening region are configured so that, with the robot cleaner docked to the station, the wettable mop accommodated in the first region, and the wettable mop rotated by the robot cleaner, the wettable mop rotates sequentially in a first direction from the first opening region, to the friction body, and then to the second opening region.

4. The station of claim 3, wherein
the first scraper further includes a guide rib that is inclined upwards with respect to the first direction from the first opening region toward the friction surface, and
the first scraper is configured so that, with the robot cleaner docked to the station, the wettable mop accommodated in the first region, and the wettable mop rotated by the robot cleaner, the guide rib guides a lower surface of the wettable mop from the first opening region to the friction surface.

5. The station of claim 4, wherein the guide rib is connected to a surface of the friction surface facing the first opening region.

6. The station of claim 1, wherein
the frame body forms a rim of the opening,
the second scraper includes a friction body protruding from a surface of the frame body and having a friction surface facing the first region, and
the second scraper is configured to allow the received water to flow along the second scraper.

7. The station of claim 6, wherein
the washing chamber includes a water supply nozzle on a first side wall of the washing chamber facing the first region, and
the wash frame further includes a water spray hole formed at the frame body and configured so that water stored in the tank passes through the water supply nozzle and the water spray hole to be received by the second scraper.

8. The station of claim 6, wherein
the friction body includes a pair of water guide walls protruding from the friction surface along a lengthwise direction of the friction body and configured to guide the received water along the second scraper.

9. The station of claim 7, wherein the water supply nozzle is inclined in a direction in which the friction surface extends.

10. The station of claim 7, further comprising:
a steam generating device including:
a steam chamber configured to hold water, and
a heater configured to heat the water held in the steam chamber to generate steam, wherein
the washing chamber further includes a steam supply opening on a second side wall of the washing chamber facing the second region,
the wash frame includes:
a steam inlet opening communicating with the steam supply opening, and
a steam spray hole communicating with the steam inlet opening and extending from the rim of the opening into the second region, and
the steam generating device, the washing chamber and the wash frame are configured so that steam generated by the heater flows through the steam supply opening, then through the steam inlet opening, and then through the steam spray hole to be discharged to the second region.

11. The station of claim 10, further comprising:
a drying device including a fan configured to generate a flow of air, wherein
the washing chamber further includes an air supply opening, the wash frame further includes an air spray hole formed through the frame body, and
the drying device, the washing chamber and the wash frame are configured so that the flow of the air generated by the fan flows through the air supply opening, and then through the air spray hole to be sprayed toward the first region and the second region.

12. The station of claim 10, wherein a diameter of the opening is less than a diameter of the wettable mop.

13. The station according claim 12, wherein the frame body further includes a mop support along the rim of the opening and along a radial direction of the opening, and configured so that, with the robot cleaner docked to the station and the wettable mop accommodated in the first region, the mop support supports the wettable mop.

14. The station according claim 1, further comprising:
a drainage frame in the washing chamber and detachably coupled to the wash frame,
wherein the drainage frame is in the second region and is configured to accommodate the dirt removed from the wettable mop through the opening and the through-hole.

15. The station according claim 14, wherein
the washing chamber includes a dirt drain hole having a first diameter at a bottom of the washing chamber,
the drainage frame further includes a filtering hole having a second diameter that is smaller than the first diameter, and
the washing chamber and the drainage frame are configured so that the dirt removed from the wettable mop through the opening and the through-hole is transferred through the filtering hole to the dirt drain hole.
